(19) United States
(12) Patent Application Publication
(10) Pub. No.: US 2025/0375356 A1
(43) Pub. Date: Dec. 11, 2025

(54) USER INTERFACES FOR TRACKING MEDICATIONS

(71) Applicant: Apple Inc., Cupertino, CA (US)

(72) Inventors: Christopher D. LAURITZEN, San Francisco, CA (US); Pablo F. CARO, San Francisco, CA (US); Nicholas D. FELTON, Sunnyvale, CA (US)

(21) Appl. No.: 18/925,827

(22) Filed: Oct. 24, 2024

Related U.S. Application Data
(60) Provisional application No. 63/657,933, filed on Jun. 9, 2024.

(51) Int. Cl. A61J 7/00; A61J 7/04

(52) U.S. Cl. CPC A61J 7/0084; A61J 7/0481

(57) ABSTRACT

The present disclosure generally relates to tracking a medication and displaying interaction factors.

### CROSS-REFERENCE TO RELATED APPLICATIONS

This application claims priority to U.S. Provisional Patent Application No. 63/657,933 entitled “USER INTERFACES FOR TRACKING MEDICATIONS,” filed on Jun. 9, 2024, the contents of which is hereby incorporated by reference in its entirety.

### FIELD

The present disclosure relates generally to computer user interfaces, and more specifically to techniques for tracking medications are displayed.

### BACKGROUND

Electronic devices optionally display health-related information.

### BRIEF SUMMARY

Some techniques for tracking medications using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for tracking medications. Such methods and interfaces optionally complement or replace other methods for tracking medications. Such methods and interfaces reduce the cognitive burden on a user and produce a more efficient human-machine interface. For battery-operated computing devices, such methods and interfaces conserve power and increase the time between battery charges.

In accordance with some embodiments, a method performed at a computer system that is in communication with one or more display generation components and one or more input devices is described. The method comprises: displaying, via the one or more display generation components, a representation of a medication that is scheduled to be taken at a respective time; detecting, via the one or more input devices, a request to log an action associated with the medication; and in response to detecting the request to log the action associated with the medication: in accordance with a determination that the action associated with the medication corresponds to a last dose of the medication, displaying, via the one or more display generation components, a first type of visual element that indicates that the action associated with the medication has been logged; and in accordance with a determination that the action associated with the medication does not correspond to the last dose of the medication, displaying, via the one or more generation components, a second type of visual element that indicates that the action associated with the medication has been logged, wherein the second type of visual element is different from the first type of visual element.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a representation of a medication that is scheduled to be taken at a respective time; detecting, via the one or more input devices, a request to log an action associated with the medication; and in response to detecting the request to log the action associated with the medication: in accordance with a determination that the action associated with the medication corresponds to a last dose of the medication, displaying, via the one or more display generation components, a first type of visual element that indicates that the action associated with the medication has been logged; and in accordance with a determination that the action associated with the medication does not correspond to the last dose of the medication, displaying, via the one or more generation components, a second type of visual element that indicates that the action associated with the medication has been logged, wherein the second type of visual element is different from the first type of visual element.

In accordance with some embodiments, a transitory computer-readable storage medium is described. The transitory computer-readable storage medium stores one or more programs configured to be executed by one or more processors of a computer system that is configured to communicate with one or more display generation components and one or more input devices, the one or more programs including instructions for: displaying, via the one or more display generation components, a representation of a medication that is scheduled to be taken at a respective time; detecting, via the one or more input devices, a request to log an action associated with the medication; and in response to detecting the request to log the action associated with the medication: in accordance with a determination that the action associated with the medication corresponds to a last dose of the medication, displaying, via the one or more display generation components, a first type of visual element that indicates that the action associated with the medication has been logged; and in accordance with a determination that the action associated with the medication does not correspond to the last dose of the medication, displaying, via the one or more generation components, a second type of visual element that indicates that the action associated with the medication has been logged, wherein the second type of visual element is different from the first type of visual element.

In accordance with some embodiments, a computer system that is configured to communicate with one or more display generation components and one or more input devices is described. The computer system comprises: one or more processors; and memory storing one or more programs configured to be executed by the one or more processors, the one or more programs including instructions for: displaying, via the one or more display generation components, a representation of a medication that is scheduled to be taken at a respective time; detecting, via the one or more input devices, a request to log an action associated with the medication; and in response to detecting the request to log the action associated with the medication: in accordance with a determination that the action associated with the medication corresponds to a last dose of the medication, displaying, via the one or more display generation components, a first type of visual element that indicates that the action associated with the medication has been logged; and in accordance with a determination that the action associated with the medication does not correspond to the last dose of the medication, displaying, via the one or more generation components, a second type of visual element that indicates that the action associated with the medication has been logged, wherein the second type of visual element is different from the first type of visual element.

In accordance with some embodiments, a computer system that is configured to communicate with one or more display generation components and one or more input devices is described. The computer system comprises: means for displaying, via the one or more display generation components, a representation of a medication that is scheduled to be taken at a respective time; means for detecting, via the one or more input devices, a request to log an action associated with the medication; and means for, in response to detecting the request to log the action associated with the medication: in accordance with a determination that the action associated with the medication corresponds to a last dose of the medication, displaying, via the one or more display generation components, a first type of visual element that indicates that the action associated with the medication has been logged; and in accordance with a determination that the action associated with the medication does not correspond to the last dose of the medication, displaying, via the one or more generation components, a second type of visual element that indicates that the action associated with the medication has been logged, wherein the second type of visual element is different from the first type of visual element.

In accordance with some embodiments, a computer program product is described. The computer program product comprises one or more programs configured to be executed by one or more processors of a computer system that is that is in communication with one or more display generation components and one or more input devices. The one or more programs include instructions for: displaying, via the one or more display generation components, a representation of a medication that is scheduled to be taken at a respective time; detecting, via the one or more input devices, a request to log an action associated with the medication; and in response to detecting the request to log the action associated with the medication: in accordance with a determination that the action associated with the medication corresponds to a last dose of the medication, displaying, via the one or more display generation components, a first type of visual element that indicates that the action associated with the medication has been logged; and in accordance with a determination that the action associated with the medication does not correspond to the last dose of the medication, displaying, via the one or more generation components, a second type of visual element that indicates that the action associated with the medication has been logged, wherein the second type of visual element is different from the first type of visual element.

In accordance with some embodiments, a method performed at a computer system that is in communication with one or more display generation components and one or more input devices is described. The method comprises: detecting, via the one or more input devices, a request to add a medication as a medication to a set of one or more tracked medications that are tracked by a medication tracking application; and in response to detecting the request to add the medication to the set of one or more tracked medications that are tracked by the medication tracking application, adding the medication to the set of one or more tracked medications; and after adding the medication and while the medication is a tracked medication, displaying, via the one or more display generation components, a user interface of the medication tracking application, wherein displaying the user interface includes: in accordance with a determination that a respective interaction factor associated with the set of one or more tracked medications corresponds to a first type of interaction factor: in accordance with a determination that a first set of criteria is satisfied, displaying, at a first portion in the user interface and via the one or more display generation components, a first selectable object that, when selected, causes the computer system to display information corresponding to the first type of interaction factor; and in accordance with a determination that the first set of criteria is not satisfied, forgoing displaying, at the first portion in the user interface, the first selectable object; and in accordance with a determination that the respective interaction factor associated with the set of one or more tracked medications corresponds to a second type of interaction factor and independent of the first set of criteria being satisfied, displaying, at the first portion in the user interface and via the one or more display generation components, a second selectable object that, when selected, causes the computer system to display information corresponding to the second type of interaction factor.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: detecting, via the one or more input devices, a request to add a medication as a medication to a set of one or more tracked medications that are tracked by a medication tracking application; and in response to detecting the request to add the medication to the set of one or more tracked medications that are tracked by the medication tracking application, adding the medication to the set of one or more tracked medications; and after adding the medication and while the medication is a tracked medication, displaying, via the one or more display generation components, a user interface of the medication tracking application, wherein displaying the user interface includes: in accordance with a determination that a respective interaction factor associated with the set of one or more tracked medications corresponds to a first type of interaction factor: in accordance with a determination that a first set of criteria is satisfied, displaying, at a first portion in the user interface and via the one or more display generation components, a first selectable object that, when selected, causes the computer system to display information corresponding to the first type of interaction factor; and in accordance with a determination that the first set of criteria is not satisfied, forgoing displaying, at the first portion in the user interface, the first selectable object; and in accordance with a determination that the respective interaction factor associated with the set of one or more tracked medications corresponds to a second type of interaction factor and independent of the first set of criteria being satisfied, displaying, at the first portion in the user interface and via the one or more display generation components, a second selectable object that, when selected, causes the computer system to display information corresponding to the second type of interaction factor.

In accordance with some embodiments, a transitory computer-readable storage medium is described. The transitory computer-readable storage medium stores one or more programs configured to be executed by one or more processors of a computer system that is configured to communicate with one or more display generation components and one or more input devices, the one or more programs including instructions for: detecting, via the one or more input devices, a request to add a medication as a medication to a set of one or more tracked medications that are tracked by a medication tracking application; and in response to detecting the request to add the medication to the set of one or more tracked medications that are tracked by the medication tracking application, adding the medication to the set of one or more tracked medications; and after adding the medication and while the medication is a tracked medication, displaying, via the one or more display generation components, a user interface of the medication tracking application, wherein displaying the user interface includes: in accordance with a determination that a respective interaction factor associated with the set of one or more tracked medications corresponds to a first type of interaction factor: in accordance with a determination that a first set of criteria is satisfied, displaying, at a first portion in the user interface and via the one or more display generation components, a first selectable object that, when selected, causes the computer system to display information corresponding to the first type of interaction factor; and in accordance with a determination that the first set of criteria is not satisfied, forgoing displaying, at the first portion in the user interface, the first selectable object; and in accordance with a determination that the respective interaction factor associated with the set of one or more tracked medications corresponds to a second type of interaction factor and independent of the first set of criteria being satisfied, displaying, at the first portion in the user interface and via the one or more display generation components, a second selectable object that, when selected, causes the computer system to display information corresponding to the second type of interaction factor.

In accordance with some embodiments, a computer system that is configured to communicate with one or more display generation components and one or more input devices is described. The computer system comprises: one or more processors; and memory storing one or more programs configured to be executed by the one or more processors, the one or more programs including instructions for: detecting, via the one or more input devices, a request to add a medication as a medication to a set of one or more tracked medications that are tracked by a medication tracking application; and in response to detecting the request to add the medication to the set of one or more tracked medications that are tracked by the medication tracking application, adding the medication to the set of one or more tracked medications; and after adding the medication and while the medication is a tracked medication, displaying, via the one or more display generation components, a user interface of the medication tracking application, wherein displaying the user interface includes: in accordance with a determination that a respective interaction factor associated with the set of one or more tracked medications corresponds to a first type of interaction factor: in accordance with a determination that a first set of criteria is satisfied, displaying, at a first portion in the user interface and via the one or more display generation components, a first selectable object that, when selected, causes the computer system to display information corresponding to the first type of interaction factor; and in accordance with a determination that the first set of criteria is not satisfied, forgoing displaying, at the first portion in the user interface, the first selectable object; and in accordance with a determination that the respective interaction factor associated with the set of one or more tracked medications corresponds to a second type of interaction factor and independent of the first set of criteria being satisfied, displaying, at the first portion in the user interface and via the one or more display generation components, a second selectable object that, when selected, causes the computer system to display information corresponding to the second type of interaction factor.

In accordance with some embodiments, a computer system that is configured to communicate with one or more display generation components and one or more input devices is described. The computer system comprises: means for detecting, via the one or more input devices, a request to add a medication as a medication to a set of one or more tracked medications that are tracked by a medication tracking application; and means for, in response to detecting the request to add the medication to the set of one or more tracked medications that are tracked by the medication tracking application, adding the medication to the set of one or more tracked medications; and means for, after adding the medication and while the medication is a tracked medication, displaying, via the one or more display generation components, a user interface of the medication tracking application, wherein displaying the user interface includes: in accordance with a determination that a respective interaction factor associated with the set of one or more tracked medications corresponds to a first type of interaction factor: in accordance with a determination that a first set of criteria is satisfied, displaying, at a first portion in the user interface and via the one or more display generation components, a first selectable object that, when selected, causes the computer system to display information corresponding to the first type of interaction factor; and in accordance with a determination that the first set of criteria is not satisfied, forgoing displaying, at the first portion in the user interface, the first selectable object; and in accordance with a determination that the respective interaction factor associated with the set of one or more tracked medications corresponds to a second type of interaction factor and independent of the first set of criteria being satisfied, displaying, at the first portion in the user interface and via the one or more display generation components, a second selectable object that, when selected, causes the computer system to display information corresponding to the second type of interaction factor.

In accordance with some embodiments, a computer program product is described. The computer program product comprises one or more programs configured to be executed by one or more processors of a computer system that is that is in communication with one or more display generation components and one or more input devices. The one or more programs include instructions for: detecting, via the one or more input devices, a request to add a medication as a medication to a set of one or more tracked medications that are tracked by a medication tracking application; and in response to detecting the request to add the medication to the set of one or more tracked medications that are tracked by the medication tracking application, adding the medication to the set of one or more tracked medications; and after adding the medication and while the medication is a tracked medication, displaying, via the one or more display generation components, a user interface of the medication tracking application, wherein displaying the user interface includes: in accordance with a determination that a respective interaction factor associated with the set of one or more tracked medications corresponds to a first type of interaction factor: in accordance with a determination that a first set of criteria is satisfied, displaying, at a first portion in the user interface and via the one or more display generation components, a first selectable object that, when selected, causes the computer system to display information corresponding to the first type of interaction factor; and in accordance with a determination that the first set of criteria is not satisfied, forgoing displaying, at the first portion in the user interface, the first selectable object; and in accordance with a determination that the respective interaction factor associated with the set of one or more tracked medications corresponds to a second type of interaction factor and independent of the first set of criteria being satisfied, displaying, at the first portion in the user interface and via the one or more display generation components, a second selectable object that, when selected, causes the computer system to display information corresponding to the second type of interaction factor.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for tracking medications, thereby increasing the effectiveness, efficiency, and user satisfaction with such devices. Such methods and interfaces may complement or replace other methods for tracking medications.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6Q illustrate exemplary user interfaces for tracking a medication, in accordance with some embodiments.

FIG. 7 is a flow diagram illustrating a method for tracking a medication, in accordance with some embodiments.

FIGS. 8A-8L illustrate exemplary user interfaces for displaying interaction factors, in accordance with some embodiments.

FIGS. 9A-9B are flow diagrams illustrating a method for displaying interaction factors, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

Electronic devices track medications in a tracking application. Electronic devices optionally log doses for these tracked medications and/or monitor interaction factors relative these tracked medications. There is a need for electronic devices that provide efficient methods and interfaces for tracking medications. Such techniques can reduce the cognitive burden on a user who track medications, thereby enhancing productivity. Further, such techniques can reduce processor and battery power otherwise wasted on redundant user inputs.

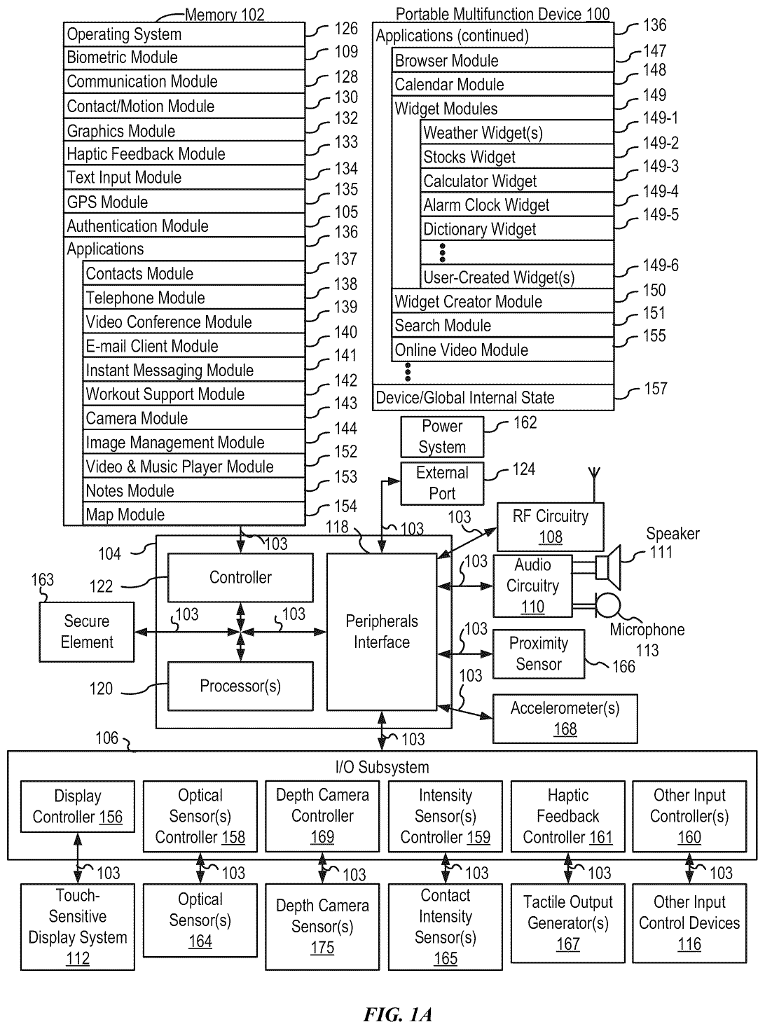

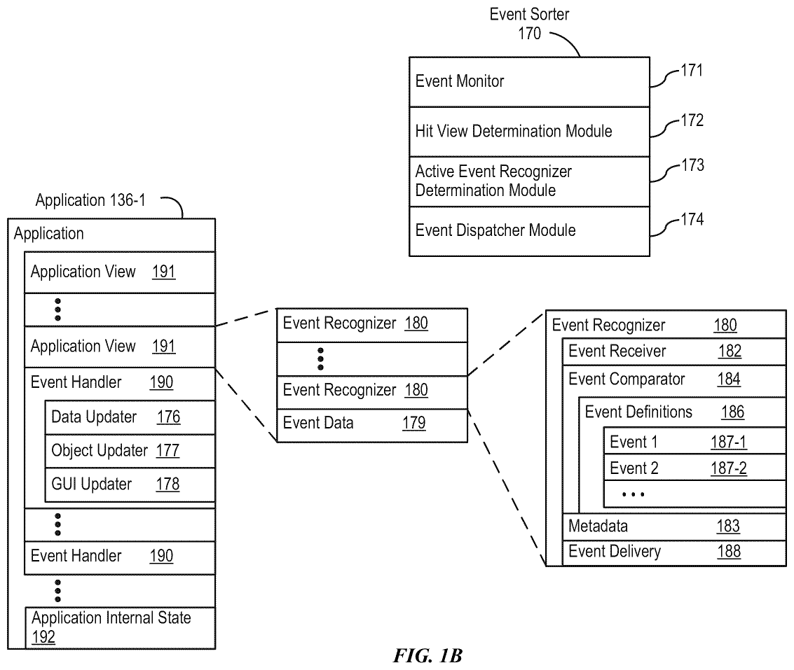

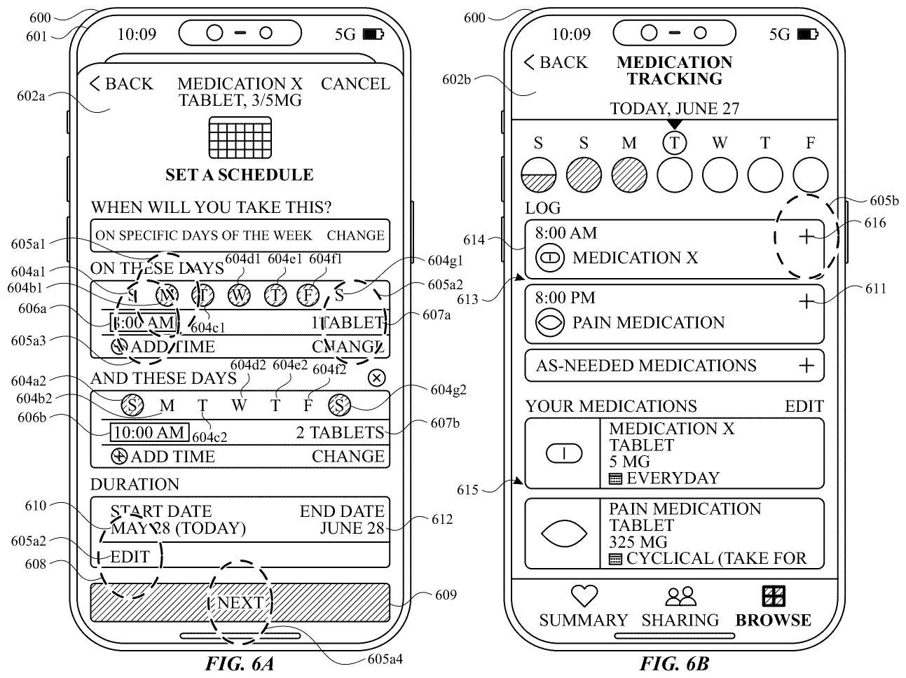

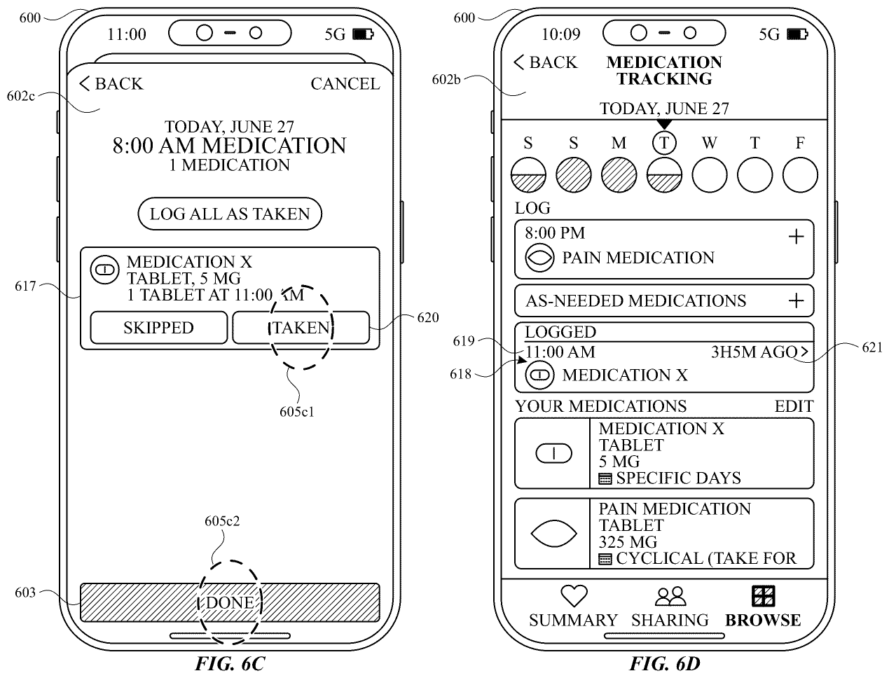

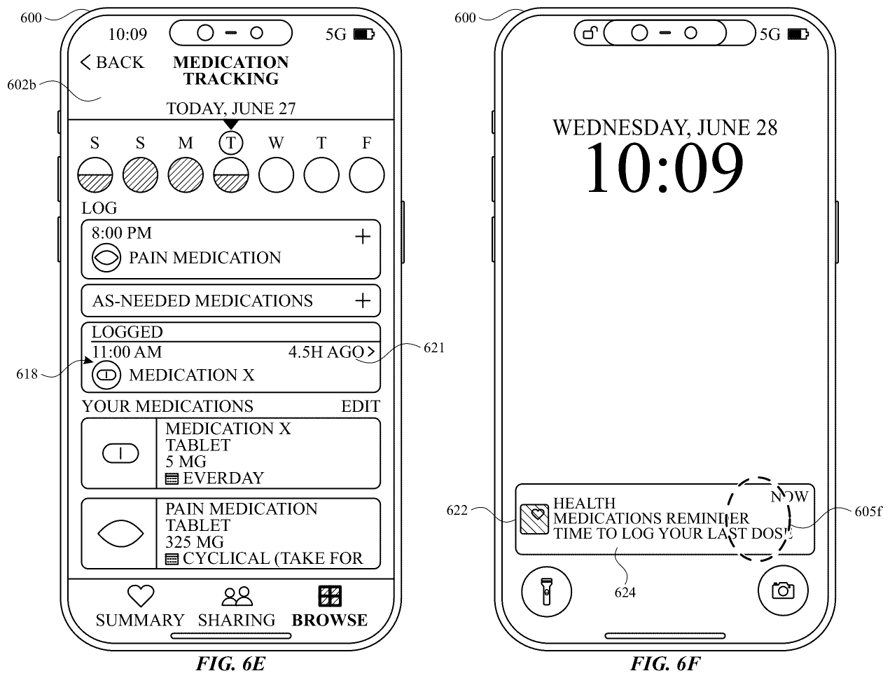

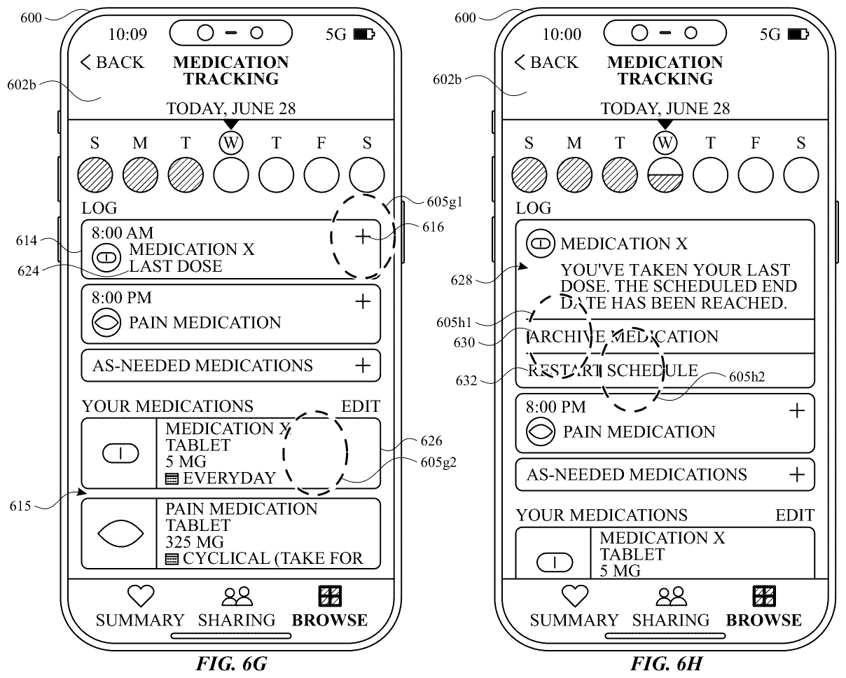

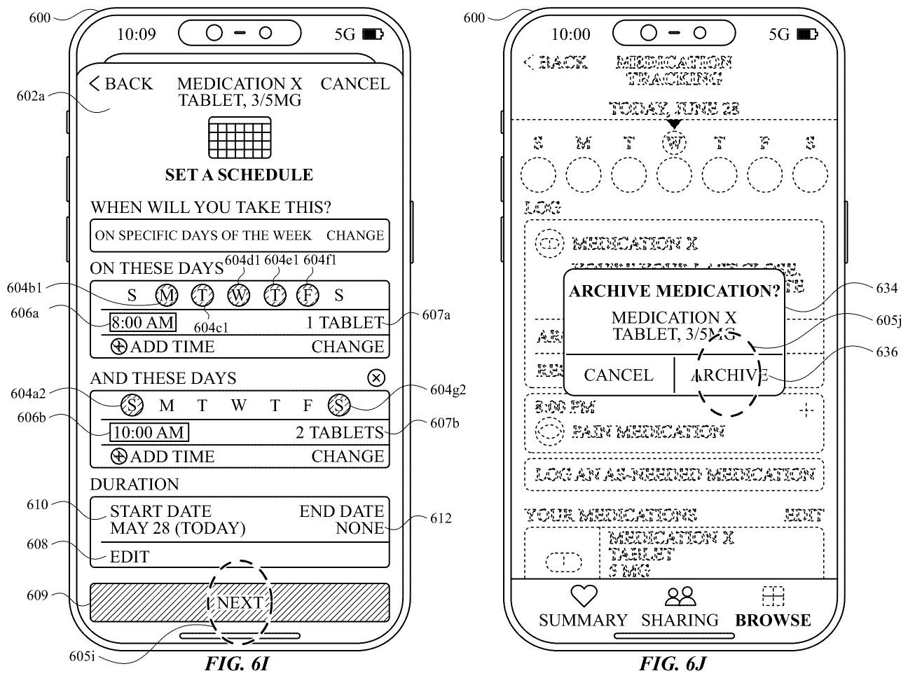

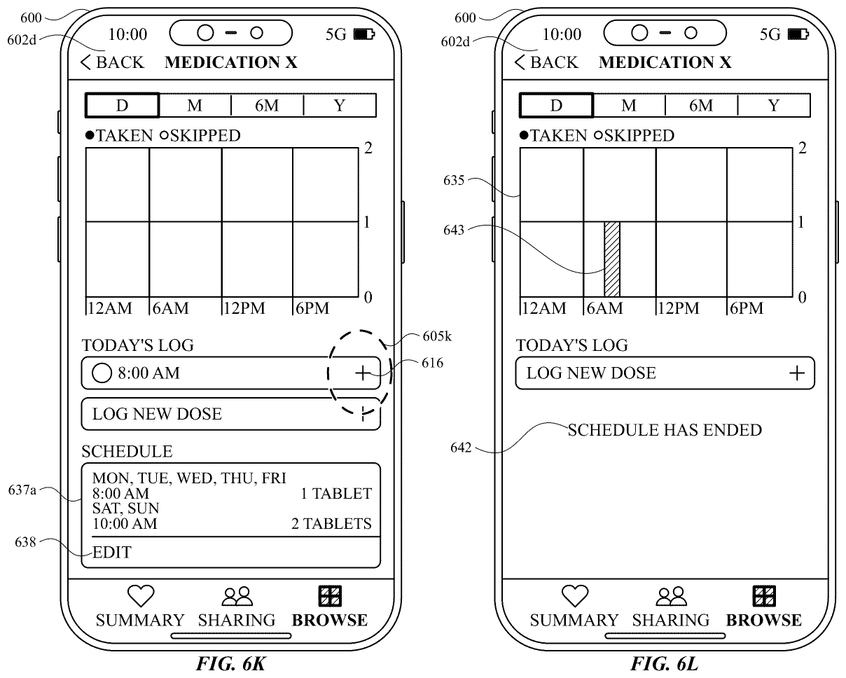

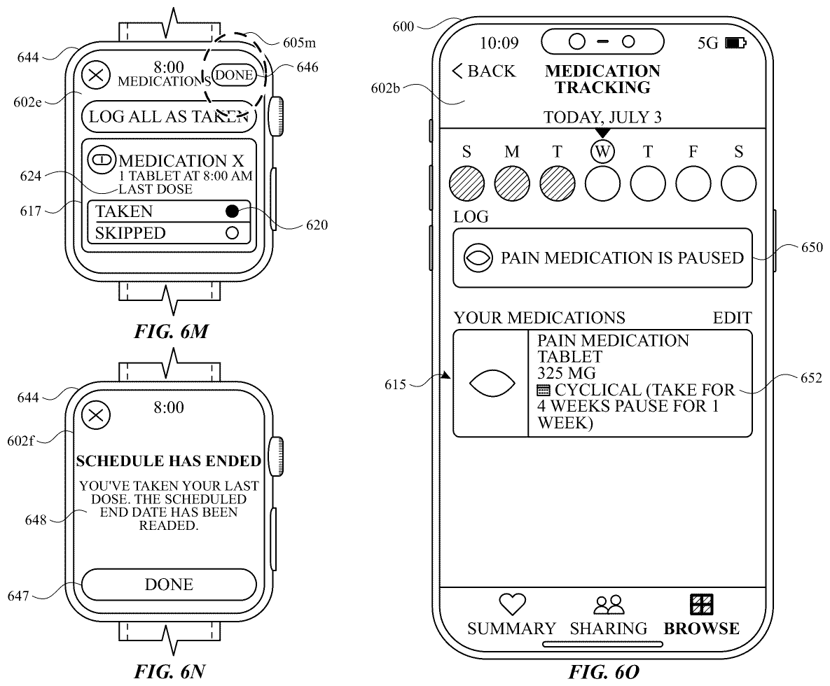

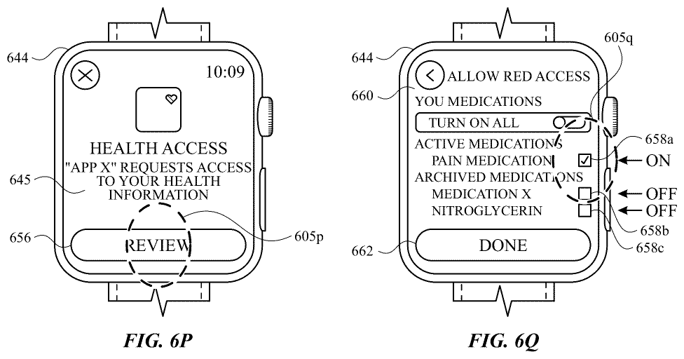

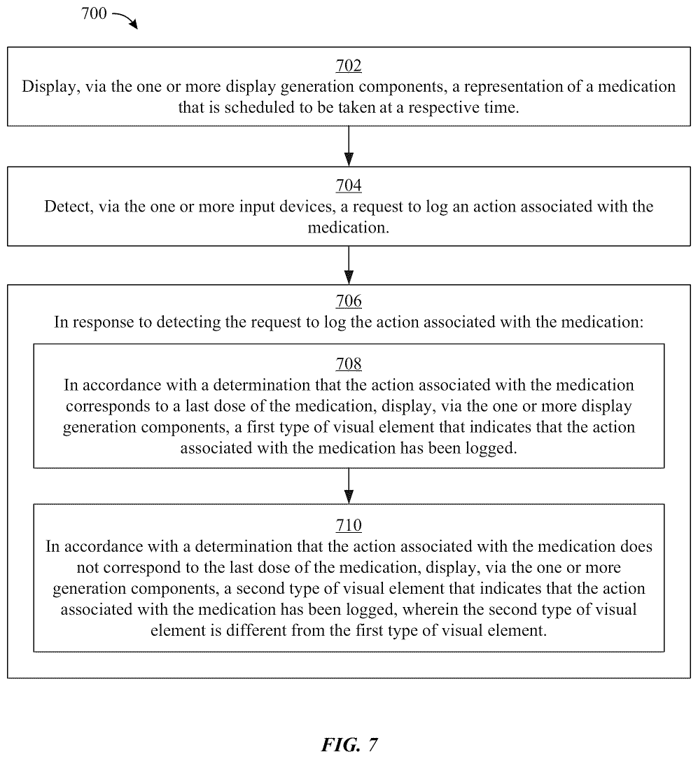

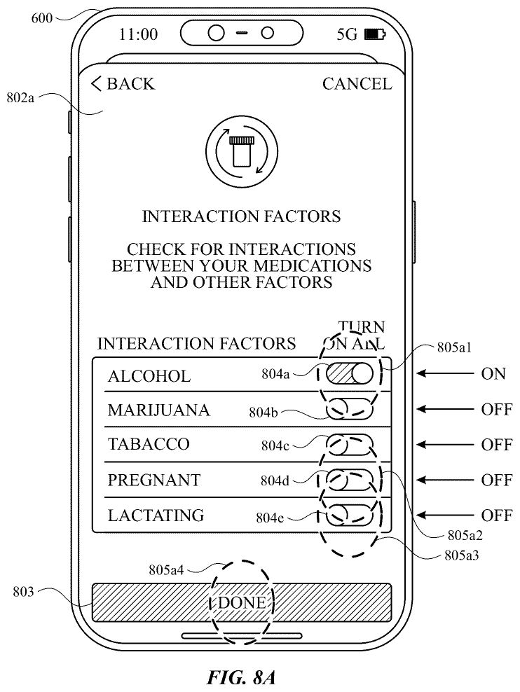

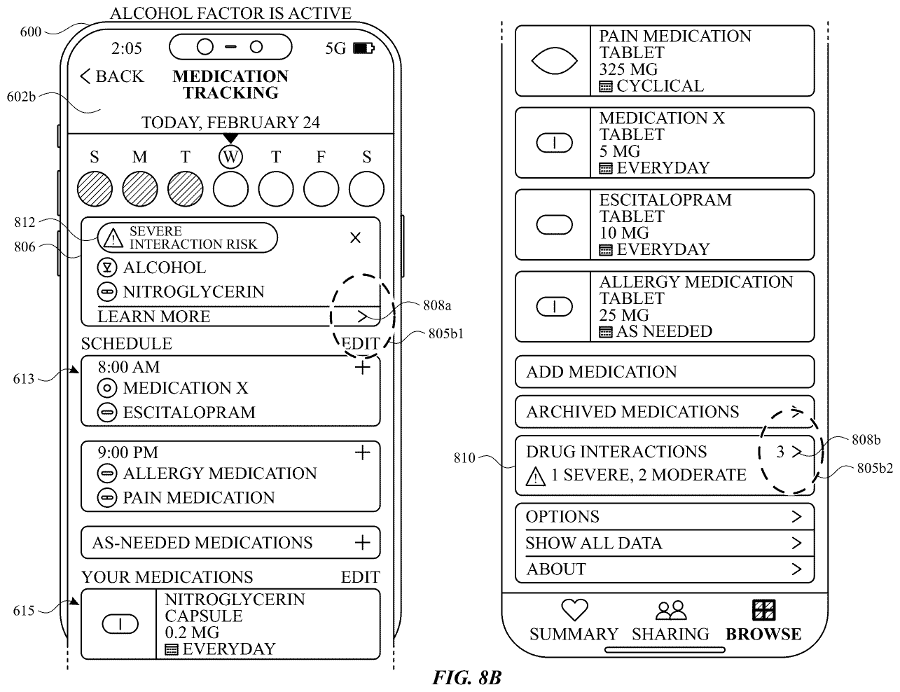

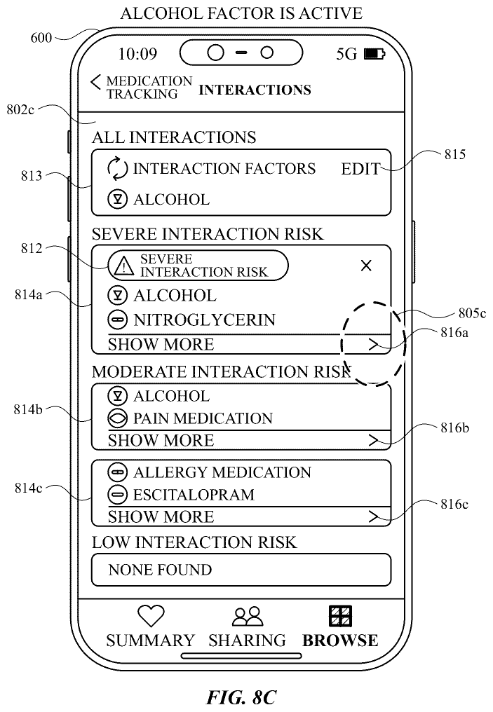

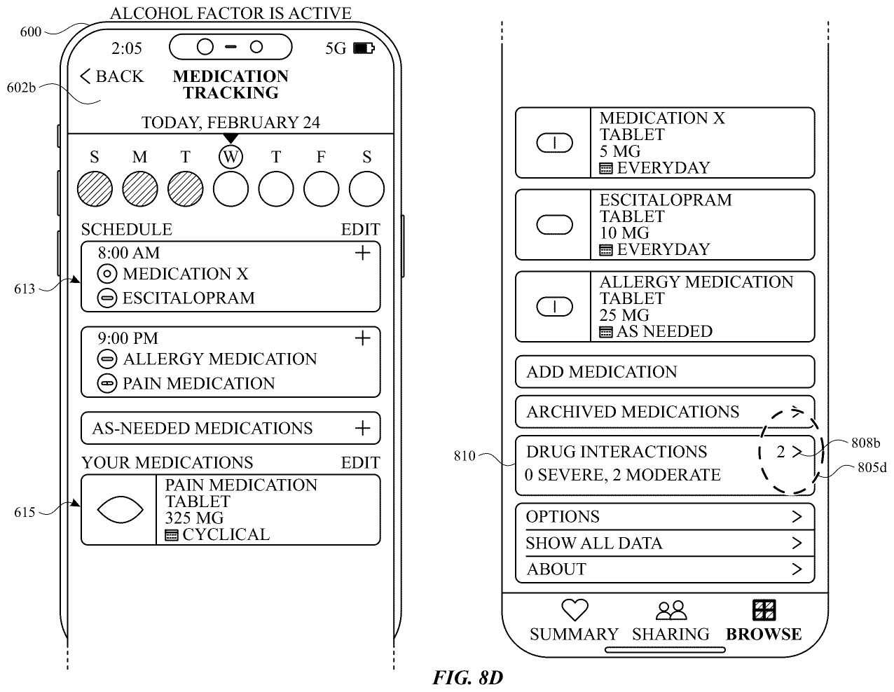

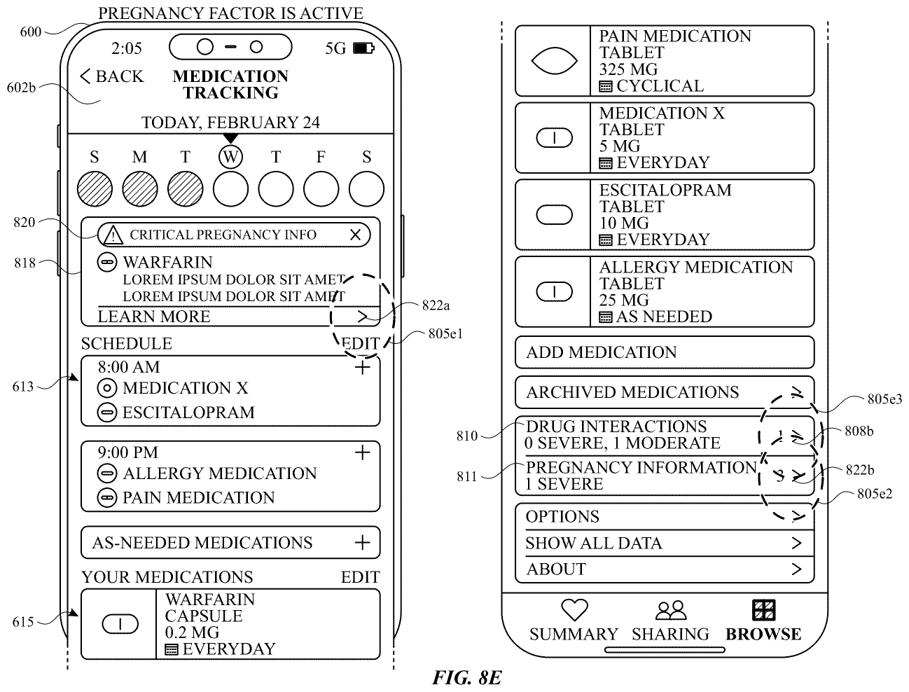

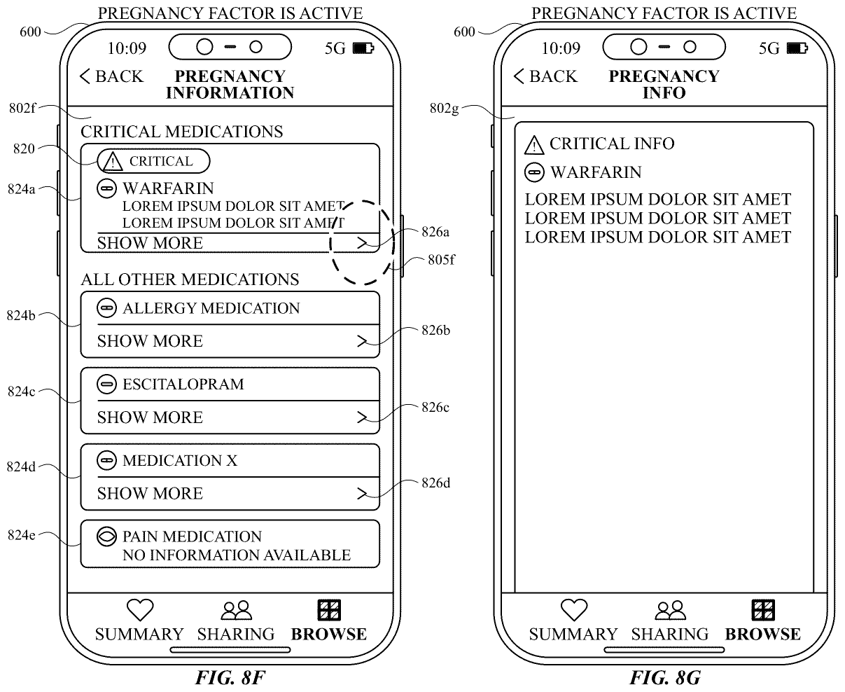

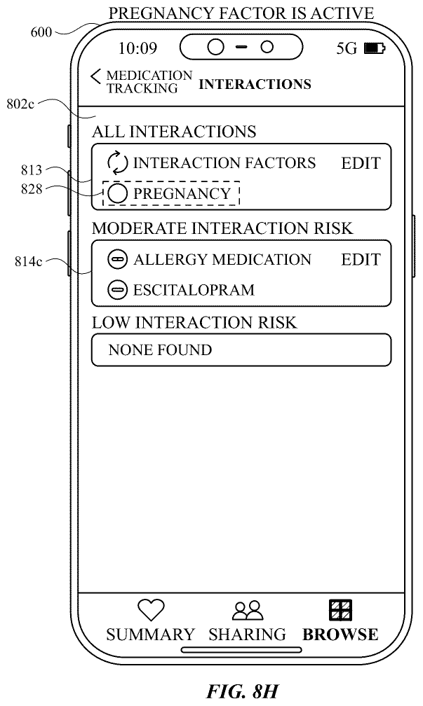

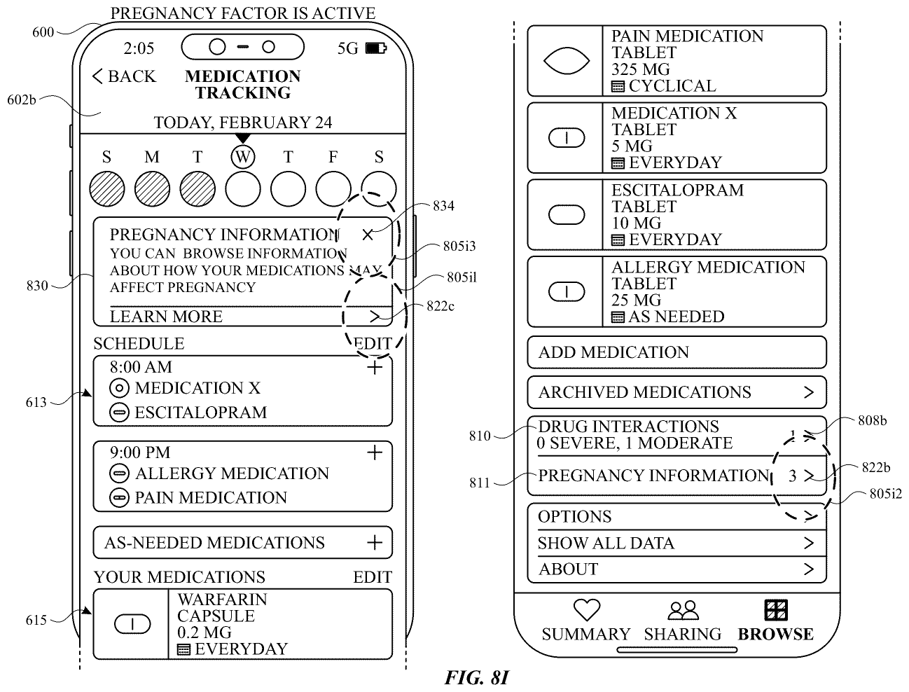

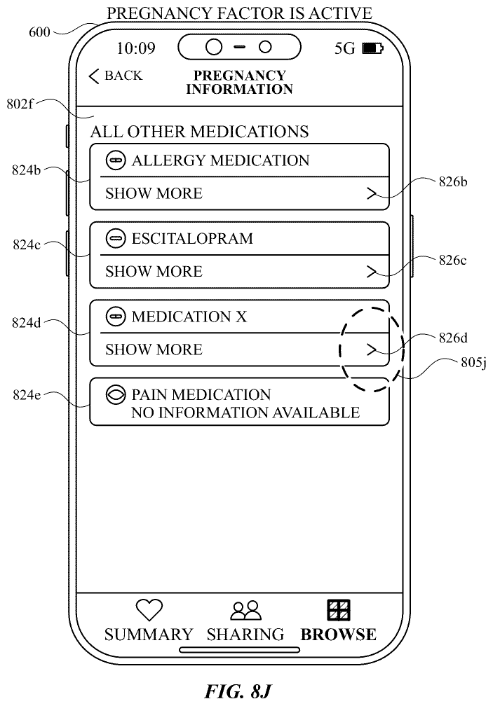

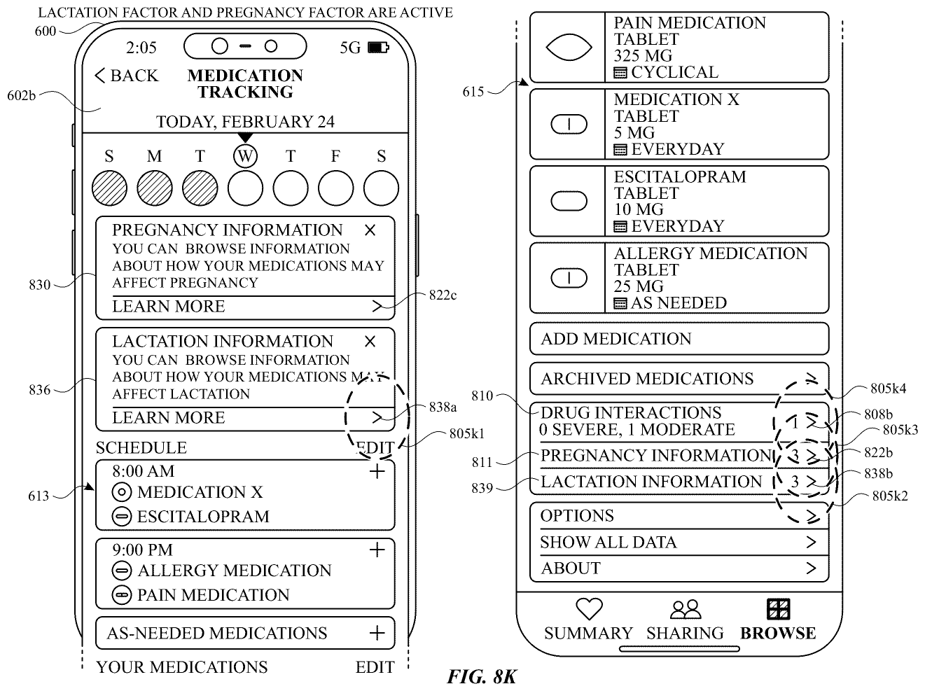

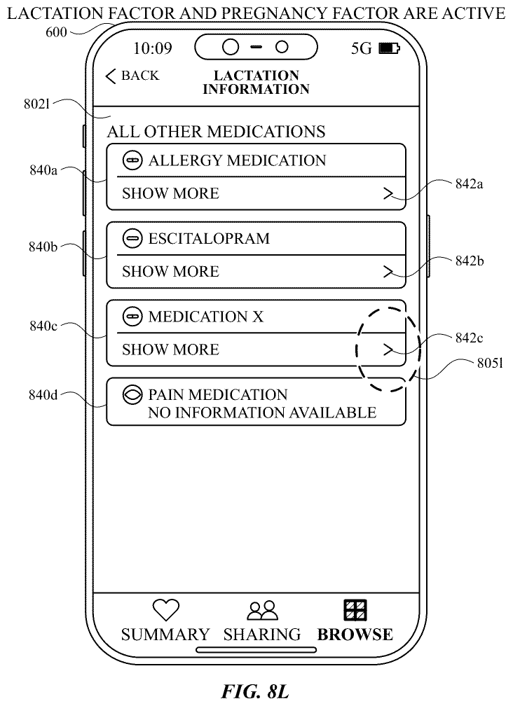

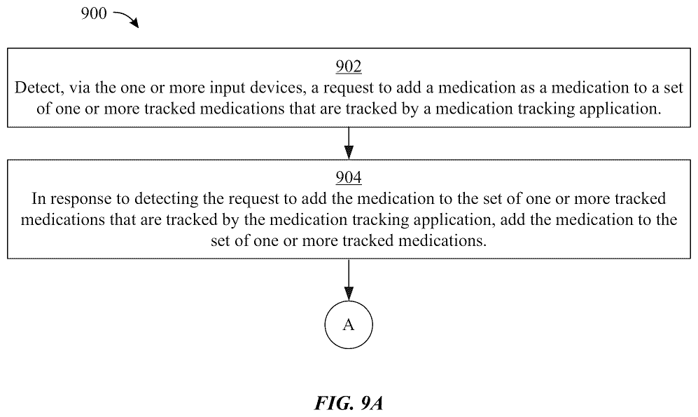

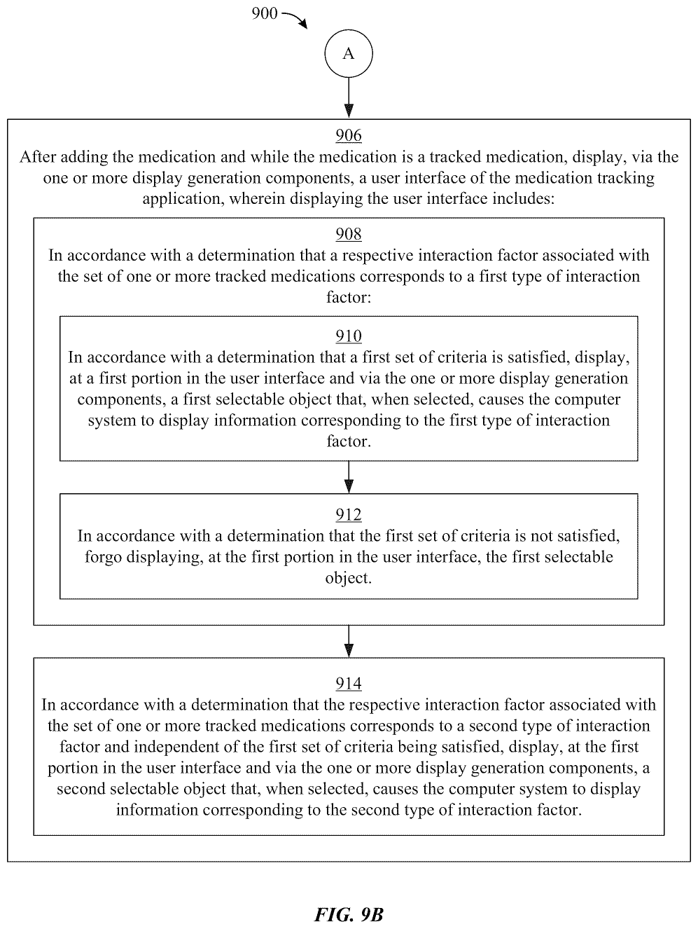

Below, FIGS. 1A-1B, 2, 3A-3G, 4A-4B, and 5A-5B provide a description of exemplary devices for performing the techniques for displaying user interfaces for tracked medications. FIGS. 6A-6Q illustrate exemplary user interfaces for tracking a medication, in accordance with some embodiments. FIG. 7 is a flow diagram illustrating a method for tracking a medication, in accordance with some embodiments. The user interfaces in FIGS. 6A-6Q are used to illustrate the processes described below, including the processes in FIG. 7. FIGS. 8A-8L illustrate exemplary user interfaces for displaying interaction factors, in accordance with some embodiments. FIGS. 9A-9B are flow diagrams illustrating a method for displaying interaction factors, in accordance with some embodiments. The user interfaces in FIGS. 8A-8L are used to illustrate the processes described below, including the processes in FIGS. 9A-9B.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it0 is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), arc, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

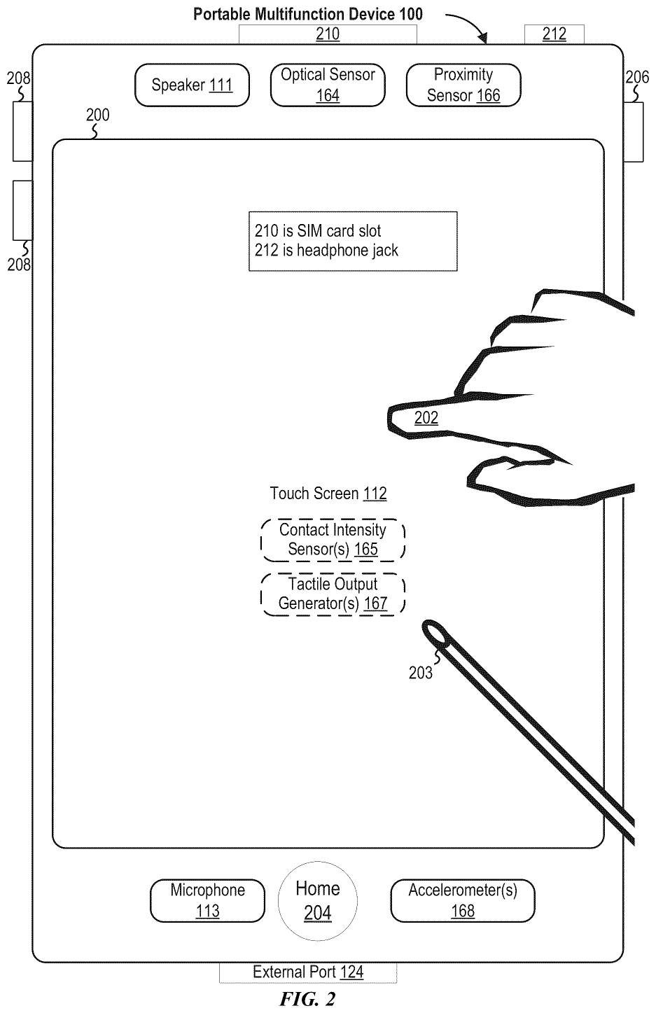

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

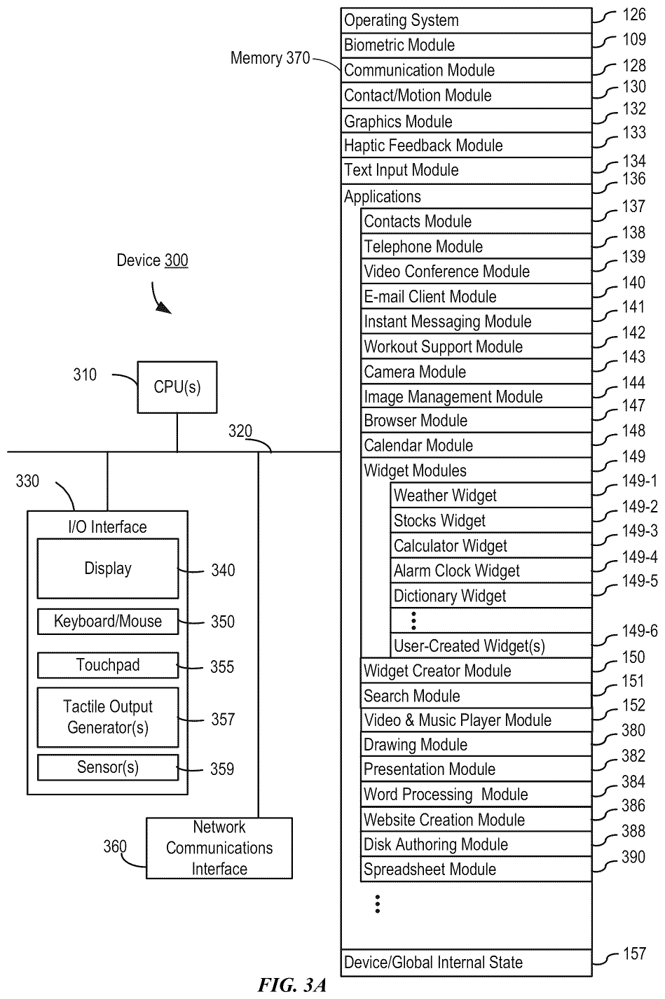

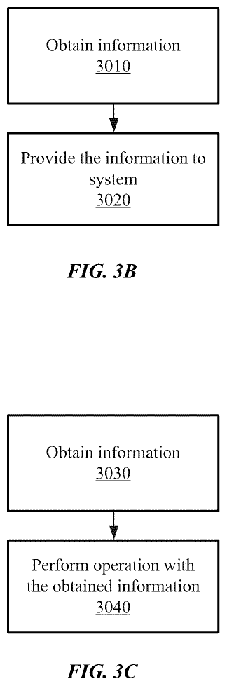

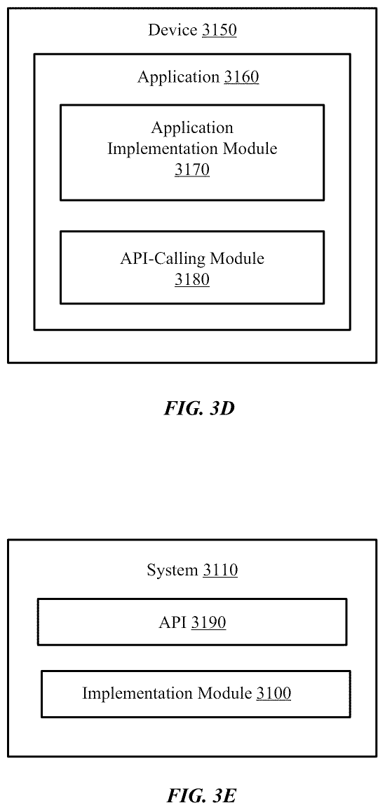

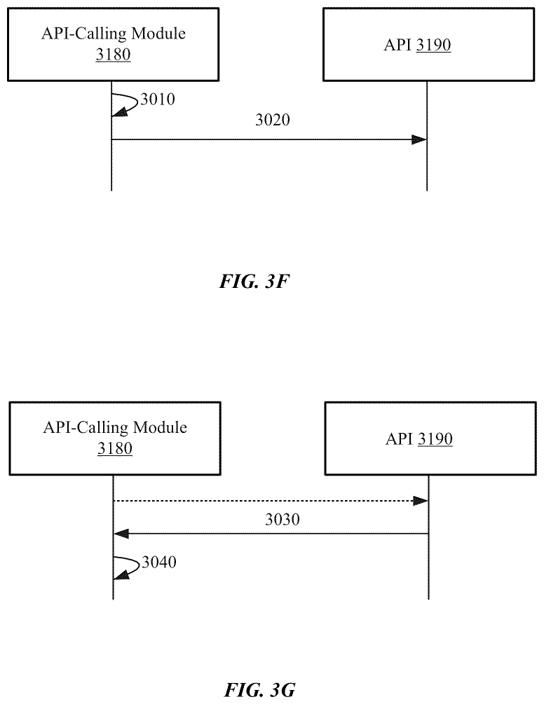

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3D, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700 and/or 900 (FIG. 7 and/or FIGS. 9A-9B) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

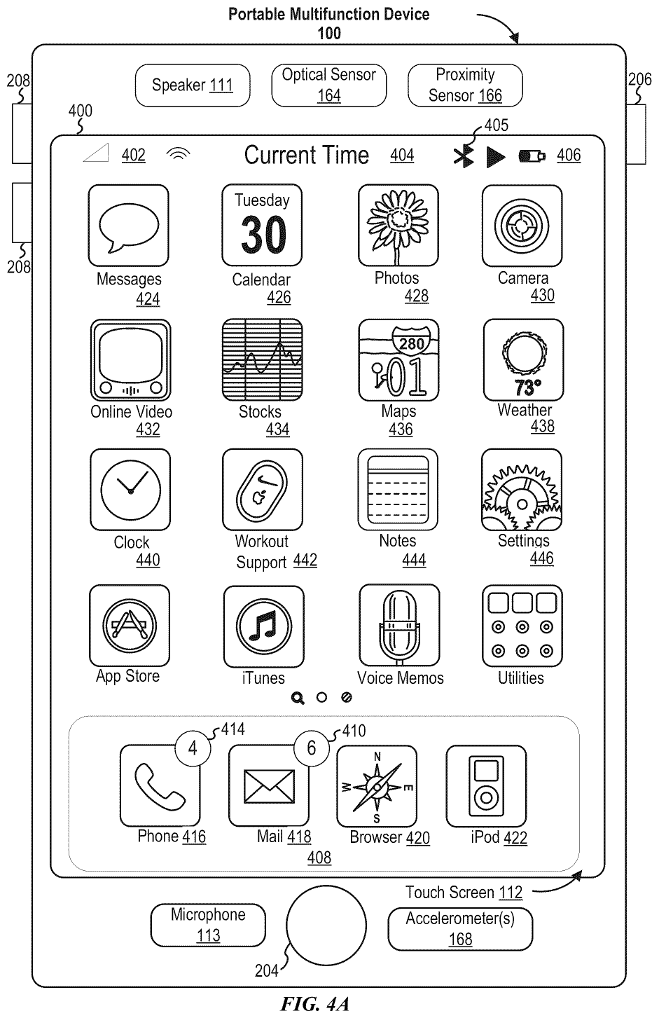

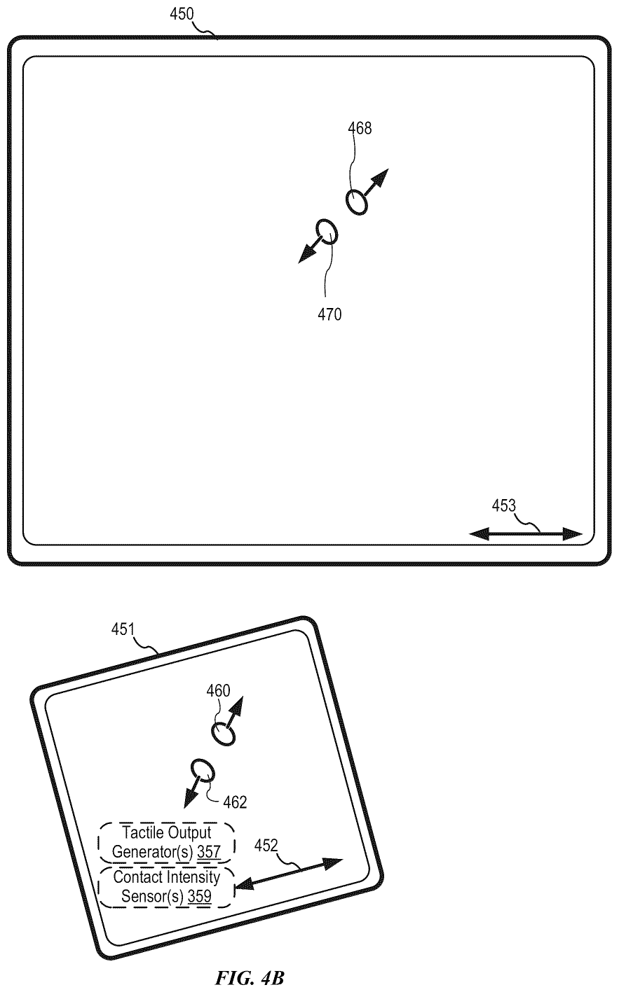

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

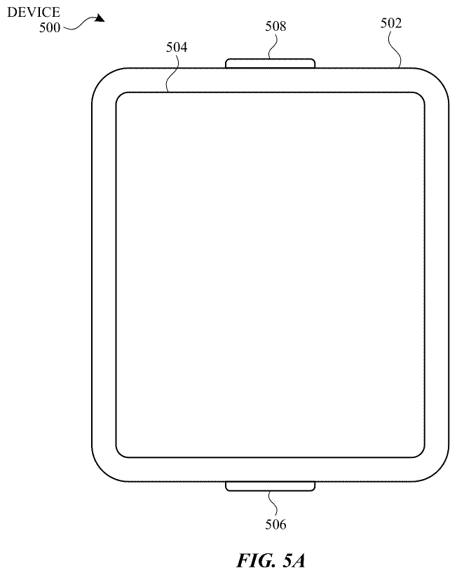

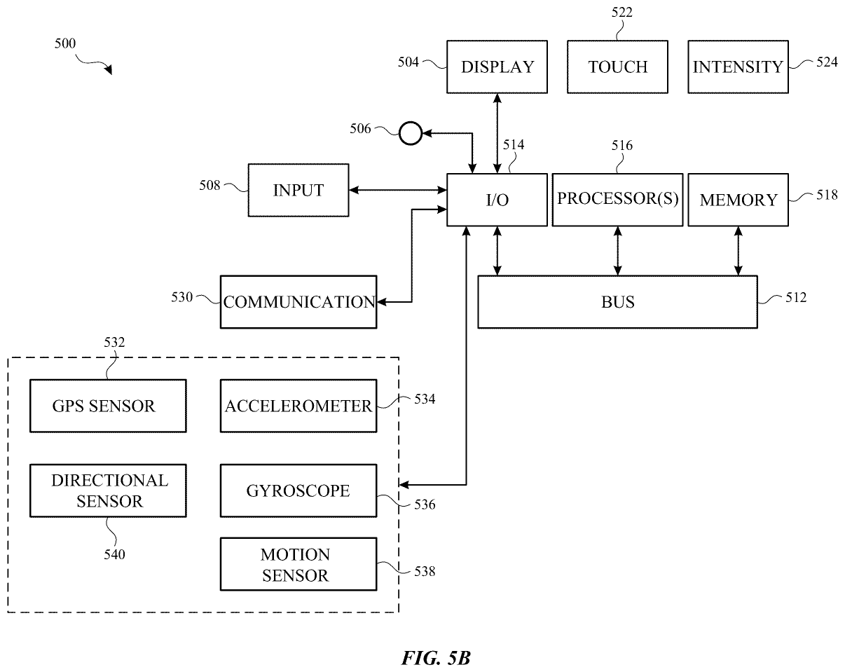

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and/or 900 (FIG. 7 and/or FIGS. 9A-9B). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6Q illustrate exemplary user interfaces for tracking a medication, in accordance with some embodiments. The user interfaces in these figures are used to illustrate the processes described below, including the processes in FIG. 7. In some embodiments, device 600 and watch device 644 of FIGS. 6A-6Q includes one or more features of portable multifunction device 100, device 300, and/or device 500. In some embodiments, device 600 and/or device 644 is a smart phone, a tablet computer, a head-mounted display (“HMD”) device, a digital media player, and/or a personal computer.

At FIG. 6A, device 600 displays, on display 601, scheduling interface 602a during a process to add medication X as a medication that is tracked by a medication tracking application. Scheduling interface 602a includes various scheduling parameters for tracking how a person consumes or applies a medication. Scheduling interface 602a includes scheduling parameters for scheduling medication X at different times and/or different doses on particular days of the week. Scheduling interface 602a includes day options 604a1-604g1 and day options 604a2-604g2 that, when activated (e.g., enabled and/or turned on), schedule medication X for a particular day of the week. As depicted, one tablet of medication X is scheduled for Monday, Tuesday, Wednesday, Thursday, and Friday at 8:00 AM. Two tablets of medication X are scheduled for Sunday and Saturday at 10 AM. In some embodiments, device 600 is configured to initiate a process to change a time that medication X is taken by activation (e.g., via input 605al (e.g., a touch input, an air gesture, a button press, a gaze, and/or a speech input)) of time parameter 606a and/or time parameter 606b. In some embodiments, device 600 is configured to change a dosage amount (e.g., the quantity of tablets taken) of medication X by selection (e.g., a touch input, an air gesture, a button press, a gaze, and/or a speech input) of dosage parameter 607a and/or dosage parameter 607b. For example, in response to detecting input 605a2 (e.g., a touch input, an air gesture, a button press, a gaze, and/or a speech input) directed to dosage parameter 607a, device 600 initiates a process to configure a dosage of medication X.

At FIG. 6A, scheduling interface 602a includes a parameter to control the scheduling of a first and last dose of medication X. Scheduling interface 602a includes start date 610 of May 28^{th} and end date 612 of June 28^{th}. In some embodiments, device 600 initiates a process to change start date 610 and end date 612 in response to detecting input 605a3 (e.g., a touch input, an air gesture, a button press, a gaze, and/or a speech input) directed to duration edit option 608. At FIG. 6A, device 600 detects input 605a4 (e.g., a touch input, an air gesture, a button press, a gaze, and/or a speech input) directed at next option 609. In response to detecting input 605a4, device 600 continues (and/or finishes) a process to add medication X as a medication that is tracked by the medication tracking application. In some embodiments, in response to detecting input 605a4, device 600 displays a summary (e.g., overview and/or conclusion) of user selections for adding medication X as a tracked medication (e.g., including a user selected representation of medication X, notes for medication X that were added by a user of device 600, user-selected scheduling parameters, and/or other information corresponding to medication X).

At FIG. 6B, device 600 displays logging interface 602b. In some embodiments, device 600 displays logging interface 602b in response to adding medication X as a tracked medication. In some embodiments, device 600 displays logging interface 602b in response to a request to open the medication tracking application and/or in response to a request to log a medication. Logging interface 602b includes logging area 613 that includes log option 616 to log an action for medication X and an option to log an action for a pain medication. As indicated in active medications area 615, medication X and a pain medication are medications that are actively tracked (actively scheduled medications and/or medications that are taken on an as-needed basis) by the medication tracking application. Logging area 613 includes logging tile 614 that indicates medication X is scheduled to be logged. Device 600 detects input 605b (e.g., a touch input, an air gesture, a button press, a gaze, and/or a speech input) directed to log option 616. In response to detecting input 605b, device 600 displays logging interface 602c of FIG. 6C. In some embodiments, device 600 detects an input (e.g., a touch input, an air gesture, a button press, a gaze, and/or a speech input) directed to log option 611 so as to log an action corresponding to the pain medication. In such embodiments, in response to detecting the input directed to log option 611, device 600 displays a logging interface similar to logging interface 602c of FIG. 6C but to log an action for the pain medication.

At FIG. 6C, logging interface 602c includes logging tile 617 to log a scheduled dose of medication X as being taken or skipped. At FIG. 6C, device 600 detects input 605cl (e.g., a touch input, an air gesture, a button press, a gaze, and/or a speech input) directed to taken option 620 and input 605c2 (e.g., a touch input, an air gesture, a button press, a gaze, and/or a speech input) directed to done option 603. In response to detecting inputs 605cl and 605c2, device 600 displays logging interface 602b of FIG. 6D.

At FIG. 6D, logging interface 602b includes logged indicator 618 of medication X. Logged indicator 618 is displayed because device 600 logged a dose of medication X. As depicted, device 600 logged a dose of medication X that was scheduled for June 27^{th}, which is the day before the day of the scheduled last dose of medication X (e.g., June 28^{th}). In some embodiments, device 600 does not display logged indicator 618 when a last dose of medication X is logged.

At FIG. 6D, logged indicator 618 includes time indicator 619 that represents a time that medication X was logged (e.g., 11:00 AM) (e.g., and not when the medication was scheduled). Logged indicator 618 also includes dynamic time indicator 621 (e.g., “3 h 5 m ago”) that represents the amount of time that has passed since medication X was logged. As depicted in FIG. 6D, a current time is 2:05 PM, and the time medication was logged was 11:00 AM.

At FIG. 6E device 600 has updated dynamic time indicator 621 in response to determining that the current time is 3:30 PM. In response to detecting that additional time has elapsed since the time medication X was logged, device 600 displays dynamic time indicator 621 indicating that 4.5 hours have passed since medication X was logged.

At FIG. 6F, device 600 displays notification 622 to log a last dose of a medication tracked by the medication tracking application. As depicted, device 600 displays notification 622 of an unlocked interface of device 600. Notification 622 includes last dose indication 624 that indicates a last dose of a medication is scheduled to be logged. Notification 622 does not identify the medication. In some embodiments, notification 622 identifies a time in which a last dose of the medication for is scheduled to be logged. At FIG. 6F, device 600 detects input 605f (e.g., a touch input, an air gesture, a button press, a gaze, and/or a speech input) directed to notification 622. In response to detecting input 605f, device 600 displays logging interface 602b of FIG. 6G. In some embodiments, in response to detecting input 605f, device 600 displays a logging tile that includes options to log medication X as taken or skipped, similar to logging tile 617 of FIG. 6C.

At FIG. 6G, logging interface 602b includes logging tile 614 that is different from logging tile 614 of FIG. 6B. Logging tile 614 of FIG. 6G includes last dose indicator 624, whereas logging tile 614 of FIG. 6B does not include last dose indicator 624. At FIG. 6G, logging tile 614 is a last scheduled dose of medication X because the last dose of medication X is scheduled to be taken on June 28^{th}, as described with respect to FIG. 6A. At FIG. 6G, device 600 detects input 605g1 (e.g., a touch input, an air gesture, a button press, a gaze, and/or a speech input) directed to log option 616. In response to detecting input 605g1, device 600 initiates a process to log the last dose of medication X. In some embodiments, in response to detecting input 605g1, device 600 displays a logging interface for medication X that is similar to logging interface 602c of FIG. 6C. At FIG. 6G, in some embodiments, device 600 detects input 605g2 (e.g., a touch input, an air gesture, a button press, a gaze, and/or a speech input) directed to medication X tile 626. In such embodiments, device 600 displays logging interface 602d of FIG. 6K.

At FIG. 6H, in response to detecting a set of one or more inputs, including input 605g1 to log the last dose of medication X, device 600 displays last dose notification 628. Last dose notification 628 includes a representation that a last dose of medication X has been logged and/or a representation that an end of a schedule for medication X has been reached. Last dose notification 628 includes one or more options to initiate a process to modify a status of medication X. For example, last dose notification 628 includes archive option 630 and restart schedule option 632. In some embodiments, device 600 detects input 605h1 (e.g., a touch input, an air gesture, a button press, a gaze, and/or a speech input) directed at archive option 630. In such embodiments, in response to detecting input 605h1, device 600 initiates a process to archive medication X, which includes displaying archive notification 634 in FIG. 6J. In some embodiments, archiving medication X includes changing medication X from an active medication (e.g., a medication that is actively tracked, a medication that has an active logging schedule, and/or a medication that is configured to be logged on an as-needed basis) to an inactive medication (e.g., a medication that is not actively tracked, a medication that does not have an active logging schedule, and/or a medication that is not configured to be logged on an as-needed basis). In some embodiments, the medication application includes information corresponding to an archived a medication (e.g., a medication name, a dosage form, a dosage amount, a past schedule of the medication, and/or notes entered by the user regarding the medication). In some embodiments, device 600 does not display an archived medication in active medication area 615. In some embodiments, device 600 does not monitor for a medication interaction between an archived medication and an active medication and/or between an archived medication and an active interaction factor (e.g., the interaction factors of FIG. 8A-8L). In some embodiments, device 600 detects input 605h2 (e.g., a touch input, an air gesture, a button press, a gaze, and/or a speech input) directed at restart schedule option 632. In such embodiments, in response to detecting input 605h2, device 600 initiates a process to restart medication X, which includes displaying scheduling interface 602a in FIG. 6I. In some embodiments, device 600 displays a logged indicator (e.g., similar to logged indicator 618 of FIG. 6D) concurrently with last dose notification 628 in response to detecting a set of one or more inputs, including input 605g1, to log the last dose of medication X.

At FIG. 6I, in response to detecting input 605h2, device 600 initiates a process to restart medication X. During the process to reschedule medication X, device 600 displays scheduling interface 602a. Scheduling interface 602a includes scheduling parameters from the most recent schedule of medication X (e.g., the schedule that was just completed). The most recent schedule of medication X included scheduling one tablet of medication X at 8:00 AM on Monday, Tuesday, Wednesday, Thursday, and Friday. The most recent schedule of medication X included scheduling two tablets of medication X at 10:00 AM on Sunday and Saturday. As depicted in FIG. 6I, scheduling interface 602a includes scheduling parameters that were auto filled from the previous schedule, including scheduling one tablet of medication X at 8:00 AM on Monday, Tuesday, Wednesday, Thursday, and Friday and scheduling two tablets of medication X at 10:00 AM on Sunday and Saturday. In some embodiments, one or more scheduling parameters can be changed during the process of rescheduling medication X. For example, in some embodiments, device 600 changes the particular days a time and/or a dosage amount is scheduled for by detecting activation (or deactivation) of day options 604a1-604g1 and/or activation (or deactivation) of day options 604a2-604g2. In some embodiments, device 600 is configured to change a time at which medication X is to be taken in response to detecting a set of inputs that includes an input (e.g., a touch input, an air gesture, a button press, a gaze, and/or a speech input) that selects time parameter 606a and/or time parameter 606b. In some embodiments, device 600 is configured to change a dosage amount of medication X in response to detecting a set of inputs that includes an input (e.g., a touch input, an air gesture, a button press, a gaze, and/or a speech input) that selects dosage parameter 607a and/or dosage parameter 607b. In some embodiments, device 600 is configured to modify other parameters, including modifying a strength of medication X (e.g., increasing a strength from 3/5 mg to 2 mg) and/or modifying a form (e.g., capsule, patch, and/or oral solution) of medication X.

At FIG. 6I, scheduling interface 602a is configured to set a new last dose. As depicted, there is no end date 612. In some embodiments, device 600 initiates a process to set a new end date in response to a selection of duration edit option 608. In some embodiments, device 600 detects input 605i (e.g., a touch input, an air gesture, a button press, a gaze, and/or a speech input) directed to next option 609 to restart the schedule of medication X after the scheduling parameters are configured and, in response, continues to track medication X based on the newly configured scheduling parameters. In some embodiments, scheduling interface 602a is not displayed during the process to reschedule medication X. In such embodiments, device 600 reschedules medication X based on the previous scheduling parameters without displaying scheduling interface 602a.

At FIG. 6J, during a process to archive medication X (and/or in response to detecting input 605h1 in FIG. 6H), device 600 displays archive notification 634. Archive notification 634 includes archive confirmation option 636 that, when selected, confirms that medication X should be archived. In some embodiments, device 600 detects input 605j (e.g., a touch input, an air gesture, a button press, a gaze, and/or a speech input) directed at archive confirmation option 636. In such embodiments, device 600 modifies a tracking status of medication X from an active medication to an archived medication. In some embodiments, an archived medication does not have an active schedule and/or is not a medication that is taken on an as-needed basis. In some embodiments, device 600 does not monitor archived medications for interactions with other medications and/or interaction factors (e.g., alcohol, marijuana, tobacco, pregnancy, and/or lactation), as described in greater detail with respect to FIGS. 8A-8L. In some embodiments, an archived medication is not displayed in active medication area 615.

At FIG. 6K, in response to detecting input 605g2 in FIG. 6G, device 600 displays logging interface 602d. Logging interface 602d is a logging interface that is specific to medication X. Logging interface 602d includes schedule 637a for logging medication X. In some embodiments, device 600 is configured to initiate a process to change the current scheduled for logging medication X (e.g., including displaying scheduling interface 602a) in response to detecting a selection of edit schedule option 638. Logging interface 602d also includes log option 616 to log a last dose of medication X at 8:00 AM. Log option 616 of FIG. 6K is similar to log option 616 of FIG. 6B and FIG. 6G but has a different state. At FIG. 6K, device 600 detects input 605k (e.g., a touch input, an air gesture, a button press, a gaze, and/or a speech input) directed to log option 616. In response to detecting input 605k, device 600 initiates a process to log medication X as described with respect to FIGS. 6B-6D, including, for example, displaying logging interface 602c.

At FIG. 6L, in response to detecting that the process to log medication X that was initiated in FIG. 6K is complete, device 600 displays logging interface 602c of FIG. 6L. Logging interface 602c includes graph 635 that includes bar 643 indicating that medication X was logged. Moreover, based on determining that the last dose of medication X was logged, device 600 displays indication 642 that the schedule for medication has ended. Device 600 does not display schedule 637a, which was displayed prior to logging the last dose of medication X. In some embodiments, device 600 displays edit schedule option 638 in logging interface 602c of FIG. 6L. In such embodiments, device 600 is configured to initiate a process to restart a schedule of medication X in response to detecting activation of edit schedule option 638.

At FIG. 6M, watch device 644 displays logging interface 602e, which is similar to logging interface 602c of FIG. 6C, but has a different state. For example, logging interface 602c of FIG. 6M includes last dose indication 624 that indicates that a last dose of medication X is going to be logged. While taken option 620 is selected, watch device 644 detects input 605m (e.g., a touch input, an air gesture, a button press, a gaze, and/or a speech input) directed to done option 646. In response to detecting input 605m, watch device 644 displays last dose notification 602f of FIG. 6N. In embodiments where watch device 644 is not logging a last dose of medication X, watch device 644 displays a logging interface similar to logging interface 602b as depicted in FIG. 6D without displaying a notification that a last dose has been logged. In some embodiments, watch device 644 is in communication with device 600. In some embodiments, watch device 644 communicates with device 600 to share medication information (e.g., logs recorded, schedules created, active medications, inactive medications, and/or newly added medications). In some embodiments, watch device 644 is associated with the same user and/or same user account as device 600. In some embodiments, watch device 644 is paired with device 600.

At FIG. 6N, last dose notification 602f includes indication 648 that the last dose of medication X has been logged. Indication 648 also indicates that the end date of the schedule has been reached. As depicted, indication 648 does not include archive option 630 and restart schedule option 632. In some embodiments, indication 648 includes archive option 630 and restart schedule option 632. In some embodiments, last dose notification 602f is dismissed in response to watch device 644 detecting a selection of dismiss notification option 647.

At FIG. 6O, as depicted in schedule indicator 652, the pain medication is on a cyclical schedule. For example, the pain medication is scheduled to be taken for four weeks and then paused (e.g., not taken) for one week. This cycle is repeated throughout a duration of taking the pain medication. At FIG. 6O, device 600 determines that the pain medication is scheduled to be paused on July 3^{rd} and, in response, does not display an option to log the pain medication in logging interface 602b (e.g., logging interface 602b of FIG. 6O does not include an option to log the pain medication while logging interface 602b of FIGS. 6B, 6C-6E, and 6G include an option to log the pain medication). Moreover, in response to determining that the pain medication is scheduled to be paused on July 3^{rd}, device 600 displays indication 650 that pain medication is paused. In some embodiments, in response to determining that medication X is an archived medication, device 600 does not display medication X tile 626 in logging interface 602b of FIG. 6O. In some embodiments, the scheduling interfaces, logging options, and/or other features depicted in FIGS. 6A-6Q are not displayed unless device 600 has been updated to a most recent version of operating system (e.g., device 600 needs to be updated before the scheduling interfaces, logging options, and/or other features depicted in FIGS. 6A-6Q are available).

At FIG. 6P, watch device 644 detects an application (e.g., a medication tracking application that is different from the medication application of FIGS. 6A-6O) is requesting access to health data. The health data includes data corresponding to medications of the medication tracking application of FIGS. 6A-6O. In response to detecting that an application is requesting access to medications of the medication tracking application of FIGS. 6A-6O, watch device 644 (and/or device 600) displays notification 645. In some embodiments, notification 645 identifies an application requesting access (e.g., “App X”). Watch device 644 detects input 605p (e.g., a touch input, an air gesture, a button press, a gaze, and/or a speech input) directed to review option 656. In response to detecting input 605p, watch device 644 displays access interface 660 of FIG. 6Q.

At FIG. 6Q, access interface 660 includes options to grant access (e.g., read access and/or write access) to the application requesting access to information for the medications of the medication application. Access interface 660 includes options 658a, 658b, and/or 658c, that, when activated (e.g., enabled and/or turned on) grant, to the application requesting access, access to information corresponding the pain medication, medication X, and/or nitroglycerin of the medication application of FIGS. 6A-6O, respectively. In some embodiments, watch device 644 activates and/or deactivates options 658a, 658b, and/or 658c in response to detecting an input, such as input 605q (e.g., a touch input, an air gesture, a button press, a gaze, and/or a speech input), directed to a respective option. In some embodiments, while option 658a is activated, watch device 644 detects an input (e.g., a button press, an air gesture, a gaze, and/or a touch gesture) directed at done option 662. In such embodiments, in response to detecting the input directed at done option 662, watch device 644 grants, to the application requesting access, access to information corresponding to the pain medication. In some embodiments, watch device 644 grants access to scheduling information for pain medication (e.g., scheduled time to log, scheduled dosage amount, and/or whether a medication is taken on an as-needed basis), logging information for pain medication (e.g., recorded logs), tracking state of the pain medication (e.g., active and/or archived), and/or properties of the pain medication (e.g., dosage strength, dosage form, and/or medication name).

FIG. 7 is a flow diagram illustrating a method for tracking a medication using a computer system in accordance with some embodiments. Method 700 is performed at a computer system (e.g., 100, 300, 500, 600, and/or 644) that is in communication with one or more display generation components (e.g., 601) (e.g., a display controller, a touch-sensitive display system, a monitor, and/or a head mounted display system) and one or more input devices (e.g., 601) (e.g., a touch-sensitive surface, a keyboard, a controller, and/or a mouse) (in some embodiments, the computer system is in communication with one or more cameras (e.g., an infrared camera, a depth camera, and/or a visible light camera)). Some operations in method 700 are, optionally, combined, the orders of some operations are, optionally, changed, and some operations are, optionally, omitted.

As described below, method 700 provides an intuitive way for tracking a medication. The method reduces the cognitive burden on a user for tracking a medication, thereby creating a more efficient human-machine interface. For battery-operated computing devices, enabling a user to track a medication faster and more efficiently conserves power and increases the time between battery charges.

The computer system displays (702), via the one or more display generation components, a representation (e.g., the text and/or image of medication X in 614 of FIGS. 6B and/or 6G) (e.g., text, such as a medication name, and/or an image, such as an icon of the medication) of a medication that is scheduled to be taken (e.g., consumed and/or applied) at a respective time (e.g., as depicted in 614 of FIGS. 6B and/or 6G) (e.g., a specific time of day and/or a specific day of the week). In some embodiments, the medication is scheduled to be taken and/or logged for a respective a period of time (e.g., a time range and/or a duration of time) and/or respective number of doses. In some embodiments, the medication is scheduled to be taken at a series of scheduled times during the time period. In some embodiments, the series of scheduled times during the time period includes a last scheduled time and at least one scheduled time that occurs before the last scheduled time.

The computer system detects (704), via the one or more input devices, a request to log an action associated with the medication (e.g., 605b, 605c1, 605g1, 605k, and/or 605m) (e.g., log a medication as “taken” or logged as “skipped”). In some embodiments, the request to log an action associated with the medication includes a set of inputs (e.g., a touch input, an air gesture, a button press, a gaze, and/or a speech input) that includes an input that is detected while the representation of the medication that is scheduled to be taken at the respective time.

In response to detecting the request to log the action associated with the medication (706) and in accordance with a determination that the action associated with the medication corresponds to a last dose of the medication (e.g., a last dose of medication X is being logged in FIGS. 6G, 6K, and 6M) (e.g., a final amount of the medication to be logged and/or taken, a dose that completes a series of doses to be logged and/or taken, a last scheduled dose to be to be logged and/or taken, and/or a dose that is scheduled to be logged and/or taken at a last scheduled time out of a series of scheduled times), the computer system displays (708), via the one or more display generation components, a first type of visual element (e.g., graphical object, image, and/or text) that indicates that the action associated with the medication has been logged (e.g., 602f, 628, 642, and/or 648).

In response to detecting the request to log the action associated with the medication (706) and in accordance with a determination that the action associated with the medication does not correspond to the last dose of the medication (e.g., a last dose is not being logged in FIG. 6C) (e.g., not a final amount of the medication to be logged and/or taken, a dose that does not complete a series of doses to be logged and/or taken, not a last scheduled dose to be to be logged and/or taken, and/or a dose that is scheduled to be logged and/or taken at a scheduled time that occurs before a last scheduled time out of a series of scheduled times), the computer system displays (710), via the one or more generation components, a second type of visual element (e.g., 618) (e.g., graphical object, image, and/or text) that indicates that the action associated with the medication has been logged (e.g., as depicted in FIGS. 6D-6E), wherein the second type of visual element is different from (e.g., is a different size, is a different shape, is a different color, includes different text, and/or includes a different image than) the first type of visual element. In some embodiments, the first type of visual element includes at least one visual characteristic (e.g., image, text, color, and/or shape) that is different from a visual characteristic of the second type of visual element (or vice versa). In some embodiments, the first type of visual element includes at least one visual characteristic (e.g., image, text, color, and/or shape) that is the same as a visual characteristic of the second type of visual element (or vice versa). In some embodiments, the first type of visual element includes a visual indication that the period of time for taking the medication is complete (e.g., the medication is no longer scheduled to be taken and/or the schedule for taking the medication is done). In some embodiments, the second type of visual element does not include the visual indication that the time period for taking the medication is complete (e.g., the medication is still scheduled to be taken and/or the schedule for taking the medication is not done). Conditionally displaying a first type of visual element that indicates that the action associated with the medication has been logged or a second type of visual element that indicates that the action associated with the medication has been logged, where the second type of visual element is different from the first type of visual element, performs an operation when a set of conditions has been met without requiring further user input, provides visual feedback that a last dose of the medication has been logged, and improves medication tracking user interfaces.

In some embodiments, the first type of visual element includes a first selectable object (e.g., 630 and/or 632) that, when selected, cause the computer system to initiate process to modify a status of the medication (e.g., 630 initiates a process to archive medication X and/or 632 initiates a process to reschedule medication x) (e.g., a tracking status of the medication and/or how the medication is managed by the medication application). In some embodiments, the process to modify the status of the medication includes modifying how the medication is categorized (e.g., active medication and/or archived medication) and/or scheduled (e.g., repeating and/or change one or more parameters of a schedule for the medication). In some embodiments, the second type of visual element does not include the set of one or more selectable objects that, when selected, cause the computer system to initiate process to modify the status of the medication. Including, in the first type of visual element, a set of one or more selectable objects that, when selected, cause the computer system to initiate process to modify a status of the medication reduces the number of inputs needed to perform an operation and improves medication tracking user interfaces.

In some embodiments, the process to modify the status of the medication includes displaying, via the one or more generation components, an inactive medication (e.g., 630 and/or 636) selectable object that, when selected, causes the computer system to initiate a process to change the medication from an active medication (e.g., medication X is an active medication in FIG. 6G) (e.g., a medication that a person is currently taking) to an inactive medication (e.g., medication X becomes an inactive medication in response to 600 detecting 605h and/or 605j) (e.g., a medication that a person no longer taking). In some embodiments, a medication is an active medication when the medication is scheduled to be taken. In some embodiments, an inactive medication is a medication that is not scheduled to be taken. In some embodiments, a medication is an active medication when the medication is configured to be taken on an as-needed basis. In some embodiments, a medication is an inactive medication when the medication is not configured to be taken on an as-needed basis. Including, in the process to modify the status of the medication, the display of a selectable object that, when selected, cause the computer system to initiate a process to change the medication from an active medication to an inactive medication reduces the number of inputs needed to perform an operation and improves medication tracking user interfaces.

In some embodiments, the process to modify the status of the medication includes displaying, via the one or more generation components, a scheduling selectable object (e.g., 632, 604a1-604g1, 604a2-604g2, 606a-606b, 607a-607b, 610, 612, and/or 608) that, when selected, causes the computer system to initiate a process to schedule (e.g., re-schedule and/or restart a schedule) one or more doses of the medication to be taken (e.g., consumed and/or applied) after the last dose (e.g., 600 initiates a process to schedule medication X in response to detecting 632 and/or an input directed at 604a1-604g1, 604a2-604g2, 607a-607b, 610, and/or 608). In some embodiments, initiating a process to track the one or more doses of the medication after the last dose includes initiating a process to configure a schedule (e.g., a schedule for a frequency of taking the medication, a schedule for a dosage amount, and/or a schedule for a time of day to take the medication) for the one or more doses of the medication. Including, in the process to modify the status of the medication, the display of a scheduling selectable object that, when selected, causes the computer system to initiate a process to schedule one or more doses of the medication to be taken after the last dose reduces the number of inputs needed to perform an operation and improves medication tracking user interfaces.

In some embodiments, the computer system detects, via one or more input devices, a first set of one or more inputs (e.g., a touch input, an air gesture, a button press, a gaze, and/or a speech input) that includes an input (e.g., 605h1) directed to the scheduling selectable object. In some embodiments, in response to detecting the first set of one or more inputs, the computer system displays a parameter user interface (e.g., 602a) that includes one or more parameter selectable objects that, when selected, cause the computer system to configure a scheduling parameter (e.g., as depicted in FIG. 6I) (e.g., how frequent the medication should be taken, what time of day the medication should be taken, and/or how many doses should be taken at a scheduled time) for the one or more doses of the medication to be taken after the last dose (e.g., 604a1-604g1, 604a2-604g2, 606a-606b, 607a-607b, 610, 612, and/or 608 schedule one or more doses after the last dose of medication X). Detecting one or more input that includes an input directed to the scheduling selectable object and, in response, displaying a user interface that includes one or more parameter selectable objects that, when selected, cause the computer system to configure a scheduling parameter for taking one or more doses of the medication reduces the number of inputs needed to perform an operation and improves medication tracking user interfaces.

In some embodiments, displaying the parameter user interface includes the computer system displaying a respective scheduling parameter (e.g., 604a1-604g1, 604a2-604g2, 606a-606b, 607a-607b, 610, 612, and/or 608) for scheduling the one or more doses of the medication to be taken after the last dose. In some embodiments, displaying a respective scheduling parameter (e.g., 604a1-604g1, 604a2-604g2, 606a-606b, 607a-607b, 610, 612, and/or 608) for scheduling the one or more doses of the medication to be taken after the last dose includes, in accordance with a determination that a first scheduling parameter (e.g., 604a1-604g1, 604a2-604g2, 606a-606b, 607a-607b, 610, 612, and/or 608 of FIG. 6A) (e.g., how frequent the medication should be taken, what time of day the medication should be taken, and/or how many doses should be taken at a scheduled time) was used to schedule the last dose (e.g., 604a1-604g1, 604a2-604g2, 606a-606b, 607a-607b, 610, 612, and/or 608 of FIG. 6A are used to schedule the last dose of medication X), the computer system displaying the first scheduling parameter as the respective scheduling parameter (e.g., 604a1-604g1, 604a2-604g2, 606a-606b, 607a-607b, 610, 612, and/or 608 of FIG. 6I are the same as 604a1-604g1, 604a2-604g2, 606a-606b, 607a-607b, 610, 612, and/or 608 of FIG. 6A). In some embodiments, displaying a respective scheduling parameter (e.g., 604a1-604g1, 604a2-604g2, 606a-606b, 607a-607b, 610, 612, and/or 608) for scheduling the one or more doses of the medication to be taken after the last dose includes, in accordance with a determination that a second scheduling parameter, different from the first scheduling parameter, was used to schedule the last dose (e.g., 604a1-604g1, 604a2-604g2, 606a-606b, 607a-607b, 610, 612, and/or 608 of FIG. 6A), the computer system displaying the second scheduling parameter as the respective scheduling parameter (e.g., 604a1-604g1, 604a2-604g2, 606a-606b, 607a-607b, 610, 612, and/or 608 of FIG. 6I would change based on 604a1-604g1, 604a2-604g2, 606a-606b, 607a-607b, 610, 612, and/or 608 of FIG. 6A changing) (e.g., a previously used parameter is suggested and/or automatically used for a parameter to be used while continuing to track of the medication). In some embodiments the first scheduling parameter and/or the second scheduling parameter were configured during a process to schedule the last dose. Conditionally displaying different scheduling parameters as the respective scheduling parameter for taking one or more doses of the medication based on which scheduling parameter was used for scheduling the last dose performs an operation when a set of conditions has been met without requiring further user input and improves medication tracking user interfaces.

In some embodiments, while displaying the parameter user interface with the first scheduling parameter as the respective scheduling parameter (e.g., as depicted in FIG. 6I), the computer system detects, via the one or more input devices, a second set of one or more inputs (e.g., an input directed at 604a1-604g1, 604a2-604g2, 606a-606b, 607a-607b, 610, 612, and/or 608 of FIG. 6I) (e.g., a touch input, an air gesture, a button press, a gaze, and/or a speech input). In some embodiments, in response to the second set of one or more inputs, the computer system changes the first scheduling parameter to a third scheduling parameter that is different from the first scheduling parameter (e.g., 600 updates an parameter of 604a1-604g1, 604a2-604g2, 606a-606b, 607a-607b, 610, 612, and/or 608 of FIG. 6I in response to detecting a set of inputs that includes an input directed at one of 604a1-604g1, 604a2-604g2, 606a-606b, 607a-607b, 610, 612, and/or 608). In some embodiments, the input is directed to a selectable object in the parameter user interface. In some embodiments, after changing the first scheduling parameter to the third scheduling parameter and before confirming a schedule for the one or more doses of the medication to be taken after the last dose, the computer system displays, via the one or more display generation components, the parameter user interface with the third scheduling parameter as the respective parameter for scheduling one or more doses of the medication after the last dose (e.g., 600 displays the updated parameter for 604a1-604g1, 604a2-604g2, 606a-606b, 607a-607b, 610, 612, and/or 608 of FIG. 6I before restarting a schedule medication X after the last dose of medication X was logged) (e.g., and without displaying the first scheduling parameter as the respective parameter). Displaying, via the one or more display generation components, the parameter user interface with the third scheduling parameter as the respective parameter for scheduling one or more doses of the medication after the last dose changing the first scheduling parameter to the third scheduling parameter and before confirming a schedule for the one or more doses of the medication to be taken after the last dose improves how the medication is scheduled after the last dose and improves medication tracking user interfaces.

In some embodiments, the one or more parameter selectable objects includes a last dose selectable object (e.g., 608) that, when selected, causes the computer system to initiate a process to set a date (e.g., calendar day and/or a day of a particular month) for a last dose (e.g., a second last dose and/or a new last dose) of the medication (e.g., selecting 608 initiates a process to set 610 and/or 612). In some embodiments, the process to set a date for a second last dose includes setting a duration for how long the one or more doses of the medication should be taken (e.g., consumed and/or applied) after the initial last dose was logged. Including, in the one or more parameter selectable objects, a last dose selectable object that, when selected, causes the computer system to initiate a process to set a date for a last dose improves how the medication is scheduled after the initial last dose was logged and improves medication tracking user interfaces.

In some embodiments, the computer system is a smart phone (e.g., 600 is a smart phone) and the first type of visual element includes a medication state selectable object (e.g., 630 and/or 632) (e.g., affordances and/or buttons) that, when selected, initiates a process to modify a status (e.g., a tracking status and/or active medication status) of the medication (e.g., selection of 630 and/or 632 initiates a process to archive medication X and/or restart a schedule of medication X, respectively) (e.g., when the last dose of the medication is logged on a smart phone, the smart phone will display a button to archive the medication and/or a button to restart tracking the medication). Displaying a medication state selectable object that, when, selected initiates a process to modify a status of the medication when the computer system is a smart phone allows improves medication tracking user interfaces.

In some embodiments, the computer system is a smart watch (e.g., 644 is a smart watch) and the first type of visual element includes a selectable object (e.g., 647) that is different from a medication state selectable object (e.g., 647) that, when selected, initiates a process to modify a status of the medication. In some embodiments, the computer system is a smart watch (e.g., 644 is a smart watch) and the first type of visual element does not include the medication state selectable object (e.g., 602f and/or 642 does not include 630 and/or 632) that, when selected, initiates a process to modify a status (e.g., a tracking status and/or active medication status) of the medication (e.g., selection of 630 and/or 632 initiates a process to archive medication X and/or restart a schedule of medication X, respectively) (e.g., when the last dose of the medication is logged on a smart phone, the smart phone will display a button to archive the medication and/or a button to restart tracking the medication). In some embodiments, the first type of visual element includes an indication that a status of the medication is configurable on an external computer system (e.g., a computer, smart phone, and/or smart watch) that is different from the second type of computer system. Including, in the first type of visual element, a selectable object that is different from the medication state selectable object when the computer system is a smart watch improves security of managing medications and improves medication tracking user interfaces.

In some embodiments, the computer system displays, via the one or more display generation components, the second type of visual element (e.g., 618) with an indicator indicating an amount (e.g., quantity and/or magnitude) of time (e.g., hours, minutes, and/or seconds) that has passed since logging the medication (e.g., 621 indicates the amount of time that has passed since medication was logged) (e.g., the amount of hours, minutes, and/or seconds that have passed since the time that the medication was logged). In some embodiments, the amount of time that has passed since logging the medication is based on a comparison of a current time and a time the medication was logged. In some embodiments, in accordance with a determination that a first amount of time has passed since logging the medication, the indicator includes a first representation of first amount of time. In some embodiments, in accordance with a determination that a second amount of time has passed since logging the medication, the second amount of time different than the first amount of time, the indicator includes a second representation of second amount of time, wherein the second representation of second amount of time is different from the first representation of first amount of time. In some embodiments, the second type of visual element includes an indicator that includes an indication of a time (e.g., time of day) that the medication was logged. Displaying the second type of visual element with an indicator indicating an amount of time that has passed since logging the medication provides visual feedback for when a medication is taken and improves medication tracking user interfaces.

In some embodiments, the medication is scheduled to be active (enabled and/or not paused) for a first time period (e.g., as depicted in 6O, pain medication is scheduled to be taken for four weeks of a cyclical schedule) (e.g., a range of a set of one or more days and/or months) and inactive (e.g., disabled and/or paused) for a second time period (e.g., as depicted in 6O, pain medication is scheduled not to be taken for one week of a cyclical schedule) (e.g., a range of one or more days and/or one or more months) that is different from the first time period. In some embodiments, in accordance with a determination that a current time corresponds to the first time period (e.g., pain medication is scheduled to be taken in FIGS. 6B, 6D, 6E, 6G), the computer system displays, via the one or more display generation components, a representation of the medication with a selectable object to initiate a process to log the medication (e.g., pain medication is displayed with 611 in FIG. 6B) (and, optionally, without displaying a representation that the medication is inactive). In some embodiments, in accordance with a determination that the current time corresponds to the second time period, the computer system displays, via the one or more display generation components, a representation that the medication is inactive (e.g., 650 and/or pain medication is displayed without 611 in FIG. 6O) (and, optionally, without displaying the selectable object to initiate a process to log the medication). In some embodiments, displaying the representation that the medication is inactive includes displaying a representation that the medication is paused (e.g., a representation that the medication does not need to be logged). Conditionally displaying a representation of the medication with a selectable object to initiate a process to log the medication or a representation that the medication is inactive based on whether the current time corresponds to the first time period or the second time period, where the medication is scheduled to be active for the first time period and inactive for a second time period performs an operation when a set of conditions has been met without requiring further user input, provides visual feedback as to the state of the medication, and improves medication tracking user interfaces.

In some embodiments, the computer system detects, via the one or more input devices, a request (e.g., 605p) (e.g., a set of one or more inputs) to provide a first medication tracking application access to (e.g., share information for and/or share details about) one or more medications of a second medication tracking application (e.g., “App X” as depicted in FIG. 6P) that is different from the first medication tracking application (e.g., “App X” is a medication tracking application that is different from the medication tracking application of FIGS. 6A-6O). In some embodiments, providing access to the one or more medications of the second medication tracking application includes sharing information (e.g., medication name, dosage, form of dosage, and/or schedule) about the one or more medications. In some embodiments, in response to detecting the request to provide the first medication tracking application access to the one or more medications of the second medication tracking application and, in accordance with a determination that the second medication tracking application includes (e.g., has information about and/or tracks) a first medication (e.g., as depicted in FIG. 6Q, pain medication as an active medication and medication X and nitroglycerin are archived medications of the medication tracking application of FIGS. 6A-6O), the computer system displays, via the one or more display generation components, a first selectable object (e.g., 858a, 858b, and/or 858c) that initiates a process to provide the first medication tracking application access to the first medication (e.g., activation of 858a, 858b, and/or 858c grants access to “App X” to pain medication, medication X, and/or nitroglycerin, respectively) (e.g., access to information corresponding to the first medication that is stored by and/or accessible to the second application) (and, in some embodiments, without providing access to a medication that is different from the first medication). In some embodiments, in response to detecting the request to provide the first medication tracking application access to the one or more medications of the second medication tracking application and, in accordance with a determination that the second medication tracking application includes (e.g., has information about and/or tracks) a second medication (e.g., pain medication, medication X, and/or nitroglycerin), different from the first medication, the computer system displays, via the one or more display generation components, a second selectable object (e.g., 858a, 858b, and/or 858c) that is different from the first selectable object and that initiates a process to provide the first medication tracking application access to the second medication (e.g., activation of 858a, 858b, and/or 858c grants access to “App X” to pain medication, medication X, and/or nitroglycerin, respectively) (and, in some embodiments, without providing access to a medication that is different from the second medication) (e.g., medications are optionally shared on a per medication basis). In some embodiments, the computer system concurrently displays the first selectable object with the first selectable object. Detecting a request to provide a first medication tracking application access to one or more medications of to a second medication tracking application that is different from the first medication tracking application and, in response, displaying different selectable objects to initiate a process to provide the first medication tracking application access to the first and/or the second medication performs an operation when a set of conditions has been met without requiring further user input and improves medication tracking user interfaces.

In some embodiments, the computer system detects, via one or more input devices, a request (e.g., one or more inputs) to configure a schedule for one or more doses (e.g., quantity or amount) (e.g., 1 tablet and/or 2 tablets) of the medication (e.g., 605h2, an input directed at 638, and/or a request to add medication X as an active medication) (e.g., while adding the medication as a medication to be tracked by a medication tracking application and/or when modifying an existing schedule of a medication that is being tracked by a medication tracking application). In some embodiments, in response to detecting the request to configure the schedule for the one or more doses of the medication, the computer system displays, via the one or more display generation components, a first dosage selectable object (e.g., 607a) that, when selected, initiates a process to schedule a first dosage amount of the medication on a first day (e.g., selecting 607a initiates a process to schedule a dosage amount of medication X for Monday, Tuesday, Wednesday, Thursday, and Friday, as depicted in FIG. 6A) (e.g., calendar day and/or day of the week). In some embodiments, in response to detecting the request to configure the schedule for the one or more doses of the medication, the computer system displays, via the one or more display generation components, a second dosage selectable object (e.g., 607b) that, when selected, initiates a process to schedule a second dosage amount of the medication on a second day (e.g., selecting 607b initiates a process to schedule a dosage amount of medication X for Saturday and Sunday, as depicted in FIG. 6A) (e.g., calendar day and/or day of the week) different from the first day, wherein the second dosage amount is different from the first dosage amount (e.g., different dosages of the medication are optionally scheduled for different times). Detecting the request to configure the schedule for one or more doses of the medication and, in response, displaying a first dosage selectable object that, when selected, initiates a process to schedule a first dosage amount of the medication on a first day and displaying a second dosage selectable object that, when selected, initiates a process to schedule a second dosage amount of the medication on a second day different from the first day, where the second dosage amount is different from the first dosage amount, provides additional control options for controlling the dosage amount and improves how medications are tracked.

In some embodiments, the computer system detects, via one or more input devices, a request (e.g., one or more inputs) to configure a schedule for the medication (e.g., 605h2, an input directed at 638, and/or a request to add medication X as an active medication) (e.g., while adding the medication as a medication to be tracked by a medication tracking application and/or when modifying an existing schedule of a medication that is being tracked by a medication tracking application). In some embodiments, in response to detecting the request to configure the schedule for the medication, the computer system displays, via the one or more display generation components, a first time selectable object (e.g., 606a) that, when selected, initiates a process to schedule the medication to be taken (e.g., applied and/or consumed) at a first time on a first day (e.g., selecting 606a initiates a process to schedule a time to take medication X on Monday, Tuesday, Wednesday, Thursday, and Friday, as depicted in FIG. 6A) (e.g., day of the week and/or calendar day). In some embodiments, in response to detecting the request to configure the schedule for the medication, the computer system displays, via the one or more display generation components, a second time selectable object (e.g., 606b) that, when selected, initiates a process to schedule the medication to be taken at a second time on a second day (e.g., selecting 606a initiates a process to schedule a time to take medication X on Saturday and Sunday, as depicted in FIG. 6A), wherein the second time is different from the first time, and wherein the second day is different from the first day. Detecting the request to configure the schedule for the medication and, in response, displaying a first time selectable object that, when selected, initiates a process to schedule the medication to be taken at a first time on a first day and displaying a second time selectable object that, when selected, initiates a process to schedule the medication to be taken at a second time on a second day, where the second time is different from the first time, and where the second day is different from the first day, provides additional control options for controlling a schedule of a medication and improves how medications are tracked.

In some embodiments, after an action for the last dose of the medication has been logged (e.g., after medication X is logged) (or, in some embodiments, in response to detecting an input that logs an action for the last dose of the medication), the computer system displays, via the one or more display generation components, an indication that a schedule for the medication is complete (e.g., as depicted by 628 in FIG. 6H and/or 642 in FIG. 6L) (e.g., an indication that no more doses are scheduled for the medication). In some embodiments, the first type of visual element that indicates that the action associated with the medication has been logged includes the indication that the schedule for the medication is complete. In some embodiments, the indication that the schedule for the medication is complete is displayed a user interface that includes an indication (e.g., a graph) of a plurality of logs for the medication over a month (or six months). Displaying, via the display generation component, an indication that a schedule for the medication is complete after an action for the last dose of the medication has been logged provides visual feedback as to the state of the medication and improves how medications are tracked.

In some embodiments, displaying the representation of the medication that is scheduled to be taken (e.g., 617, 622, and/or 624) includes, in accordance with a determination that the action associated with the medication corresponds to a last dose of the medication (e.g., a last dose of medication x is being logged in FIGS. 6G, 6K, and 6M), the computer system displaying, via the one or more display generation components, the representation of the medication that is scheduled to be taken with a graphical element (e.g., 624) (e.g., graphical object, image, and/or text) that indicates that the medication that is scheduled to be taken corresponds to the last dose of the medication. In some embodiments, displaying the representation of the medication that is scheduled to be taken (e.g., 617, 622, and/or 624) includes, in accordance with a determination that the action associated with the medication does not correspond to the last dose of the medication (e.g., a last dose is not being logged in FIG. 6C), displaying, via the one or more display generation components, the representation of the medication that is scheduled to be taken without the graphical element that indicates that the medication that is scheduled to be taken corresponds to the last dose of the medication (e.g., as depicted in FIG. 6C). Conditionally displaying the representation of the medication with or without the graphical element that indicates that the medication that is scheduled to be taken corresponds to the last dose of the medication performs an operation when a set of conditions has been met without requiring further user input, provides visual feedback that a last dose of the medication will be logged, and improves medication tracking user interfaces.

Note that details of the processes described above with respect to method 700 (e.g., FIG. 7) are also applicable in an analogous manner to the methods described below. For example, method 900 optionally includes one or more of the characteristics of the various methods described above with reference to method 700. For example, a medication that is logged via method 700 can also be the same medication for which interaction factors are displayed according to method 900. For example, method 900 includes features for tracking a medication. As a further example, method 900 includes features for displaying different graphical objects when a last dose of a medication is logged. As a further example, method 900 includes features to initiate a process to modify a status of a medication when a last dose of a medication is logged. For brevity, these details are not repeated below.

FIGS. 8A-8L illustrate exemplary user interfaces for displaying interaction factors, in accordance with some embodiments. The user interfaces in these figures are used to illustrate the processes described below, including the processes in FIG. 9. In some embodiments, the features of FIGS. 8A-8L having the same reference number as the features in FIGS. 6A-6Q correspond to the same feature, but having a different state.

At FIG. 8A, device 600 displays interaction factor interface 802a. Interaction factor interface 802a includes multiple interaction factors that, when activated (e.g., enabled and/or turned on), are monitored by device 600 to determine if there is any negative interaction (e.g., an adverse side effect, a risk to a person's health, and/or a decrease in effectiveness of a medication) between an active interaction factor and a medication that is tracked by a medication application (e.g., the same medication application described with respect to FIGS. 6A-6Q). As depicted, the interaction factors include alcohol, marijuana, tobacco, pregnancy, and lactation. Device 600 is configured to activate (and/or deactivate) alcohol, marijuana, tobacco, pregnancy, and lactation interaction factors in response to detecting an input (e.g., a touch input, an air gesture, a button press, a gaze, and/or a speech input) directed to options 804a, 804b, 804c, 804d, and 804c, respectively. For example, in some embodiments, device 600 detects input 805al (e.g., a touch input, an air gesture, a button press, a gaze, and/or a speech input) directed at alcohol option 804a and, in response, deactivates alcohol as an interaction factor. In some embodiments, device 600 detects input 805a2 (e.g., a touch input, an air gesture, a button press, a gaze, and/or a speech input) directed at pregnancy option 804d and, in response, activates pregnancy as an interaction factor. In some embodiments, device 600 detects input 805a3 (e.g., a touch input, an air gesture, a button press, a gaze, and/or a speech input) directed at lactation option 804e and, in response, activates lactation as an interaction factor. Device 600 is configured to activate any combination of alcohol, marijuana, tobacco, pregnancy, and/or lactation interaction factors. In some embodiments, device 600 is configured to activate all alcohol, marijuana, tobacco, pregnancy, and lactation interaction factors. In some embodiments, device 600 displays interaction factor interface 802a during a process to add a medication to be tracked by the medication application. In some embodiments, device 600 displays interaction factor interface 802a in response to a request to change (e.g., activate and/or deactivate) an interaction factor (e.g., where the request to change the interaction factor includes an input directed to edit interaction factor option 815 of FIG. 8C). In some embodiments, device 600 detects input 805a4 (e.g., a touch input, an air gesture, a button press, a gaze, and/or a speech input) directed at done option 803 while the alcohol interaction factor is active. In response to detecting input 805a4, device 600 activates the alcohol interaction factor and continues a process to add a medication and/or displays logging interface 602b of FIG. 8B.

At FIG. 8B, the alcohol interaction factor is active and all other interaction factors are inactive. Device 600 displays logging interface 602b with severe interaction tile 806 based on determining that alcohol has a risk of a severe interaction with nitroglycerin (e.g., a currently active medication, as illustrated by a nitroglycerin tile being displayed in active medication area 615). In some embodiments, device 600 determines the interaction between the alcohol interaction factor and nitroglycerin satisfies a threshold level of severity (e.g., severe versus not severe). Device 600 displays severe interaction tile 806 above logging area 613 and above active medication area 615. Severe interaction tile 806 includes a representation of source of the severe interaction (e.g., alcohol and nitroglycerin) and includes severe graphical element 812 that indicates a level of severity of the interaction (e.g., a severe interaction risk). In some embodiments, device 600 closes severe interaction tile 806 in response to detecting selection of a close icon corresponding to severe interaction tile 806.

At FIG. 8B, device 600 displays additional information options 808a and 808b in two different portions of logging interface 602b. As depicted, device 600 displays additional information option 808a at a top portion of logging interface 602b (e.g., and/or in severe interaction tile 806). Device 600 displays additional information option 808b at a bottom portion of logging interface 602b (e.g., and/or in general interaction tile 810). As depicted, general interaction tile 810 is displayed below logging area 613 and/or below active medication area 615. General interaction tile 810 includes information (e.g., “1 severe, 2 moderate”) about drug-on-drug interactions and/or interactions between a medication and the alcohol, marijuana, and/or tobacco interaction factors. In some embodiments, additional information option 808a is similar to information option 808b but has a different state.

At FIG. 8B, device 600 detects a request to view additional information corresponding to severe interaction tile 806 and/or interaction information of general interaction tile 810. For example, device 600 detects input 805bl (e.g., a touch input, an air gesture, a button press, a gaze, and/or a speech input) directed at additional information option 808a in severe interaction tile 806. In response to detecting input 805b1, device 600 displays general interaction interface 802c in FIG. 8C. At FIG. 8B, device 600 detects input 805b2 (e.g., a touch input, an air gesture, a button press, a gaze, and/or a speech input) directed at additional information option 808b. In response to detecting input 805b2, device 600 displays general interaction interface 802c in FIG. 8C.

At FIG. 8C, in response to detecting input 805bl and/or 805b2, device 600 displays general interaction interface 802c. General interaction interface 802c includes severe interaction tile 814a that is similar to severe interaction tile 806 but has a different state. In some embodiments, severe interaction tile 814a of general interaction interface 802c includes different information than severe interaction tile 806. General interaction interface 802c also includes moderate interaction tiles 814b and 814c. Moderate interaction tile 814b indicates there is an interaction between alcohol and the pain medication. Moderate interaction tile 814c indicates there is an interaction between allergy medication and escitalopram (e.g., an interaction between two active medications). In some embodiments, moderate interaction tiles 814b and 814c include information corresponding to the respective interactions.

At FIG. 8C, device 600 detects a request to display additional information corresponding to severe interaction tile 806, moderate interaction tile 814b, and/or moderate interaction tile 814c. In some embodiments, device 600 displays additional information corresponding to severe interaction tile 806, moderate interaction tile 814b, and/or moderate interaction tile 814c in response to detecting an input (e.g., a touch input, an air gesture, a button press, a gaze, and/or a speech input) directed to show more options 816a, 816b, and/or 816c, respectively. For example, in some embodiments, in response to detecting input 805c (e.g., a touch input, an air gesture, a button press, a gaze, and/or a speech input), device 600 displays additional information about the interaction between alcohol and nitroglycerin. In some embodiments, device 600 determines that marijuana and/or tobacco interaction factors are active and that marijuana and/or tobacco interacts with a currently active medication and, in response, displays an interaction between marijuana and/or tobacco and the currently active medication in general interaction interface 802c.

At FIG. 8C, general interaction interface 802c includes a list of active interaction factors in active interaction factor tile 813. In some embodiments, device 600 is configured to change which interaction factors are active and/or deactivated. For example, in some embodiments, device 600 detects an input (e.g., a button press, an air gesture, a gaze, and/or a touch gesture) directed to edit interaction factor option 815 and, in response, displays interaction factor interface 802a of FIG. 8A.

At FIG. 8D, the alcohol interaction factor is active and device 600 displays logging interface 602b without a severe interaction like severe interaction tile 806 based on determining that there is no severe interaction between alcohol and any of the currently active medications (e.g., the medications displayed in active medication area 615). In response to determining that there are no severe interactions between alcohol interaction factor and the currently active medications, device 600 does not display a severe interaction tile (e.g., similar to severe interaction tile 806 of FIG. 8C).

At FIG. 8D, logging interface 602b includes general interaction tile 810. General interaction tile 810 of FIG. 8D is different from general interaction tile 810 of FIG. 8C. General interaction tile 810 of FIG. 8D does not include a severe interaction between alcohol and nitroglycerin based on determining that nitroglycerin is not an active medication (e.g., nitroglycerin has been archived and/or deleted). General interaction tile 810 of FIG. 8D includes two moderate interactions based on device 600 determining that there are two moderate interactions, one between the alcohol interaction factor and the pain medication and one between escitalopram and the allergy medication. In some embodiments, device 600 detects input 805d (e.g., a touch input, an air gesture, a button press, a gaze, and/or a speech input) directed at show more option 816a. In such embodiments, in response to detecting input 805d, device 600 displays a general interaction interface similar to general interaction interface 802c of FIG. 8C but having a different state (e.g., the general interaction interface does not include severe interaction tile 814a depicted in general interaction interface 802c of FIG. 8C).

At FIG. 8E, the pregnancy interaction factor is active and all other interaction factors are inactive. Device 600 displays logging interface 602b with severe pregnancy interaction tile 818 based on a determination that there is a severe interaction between the pregnancy interaction factor and warfarin (e.g., a currently active medication, as illustrated by a nitroglycerin tile being displayed in active medication area 615). In some embodiments, device 600 determines the interaction between pregnancy interaction factor and warfarin satisfies the threshold level of severity. Device 600 displays severe pregnancy interaction tile 818 above logging area 613 and/or above active medication area 615. Severe pregnancy interaction tile 818 includes a representation of source of the severe interaction (e.g., pregnancy and warfarin) and includes severe graphical element 820 that indicates a level of severity of the interaction (e.g., a severe interaction). In some embodiments, device 600 displays severe pregnancy interaction tile 818 upon initially displaying logging interface after a determination that there is an interaction between being pregnant and taking warfarin. In some embodiments, device 600 closes severe pregnancy interaction tile 818 in response to detecting selection of a close icon corresponding to severe pregnancy interaction tile 818.

At FIG. 8E, device 600 displays pregnancy information options 822a and 822b in different portions of logging interface 602b. As depicted, device 600 displays pregnancy information option 822a at a top portion of logging interface 602b (e.g., and/or in severe pregnancy interaction tile 818). Device 600 displays pregnancy information option 822b at a bottom portion of logging interface 602b (e.g., and/or in pregnancy interaction tile 811). As depicted, pregnancy interaction tile 811 is displayed below logging area 613, below active medication area 615, and/or below general interaction tile 810. Pregnancy interaction tile 811 includes information (e.g., “1 severe”) about interactions between a medication and the pregnancy interaction factor. Pregnancy interaction tile 811 also includes information about non-severe interactions (e.g., “3”). As described in greater detail with respect to FIG. 8F, there are three interactions based on three of the active medications having an interaction with pregnancy.

In some embodiments, pregnancy interaction tile 811 does not include information corresponding to a drug-on-drug interaction and/or does not include information corresponding to an interaction between a medication and one of alcohol, marijuana, and/or tobacco interaction factors.

At FIG. 8E, device 600 detects a request to view additional information corresponding to the pregnancy interaction factor and/or general interaction factors. For example, device 600 detects input 805c1 (e.g., a touch input, an air gesture, a button press, a gaze, and/or a speech input) directed at pregnancy information option 822a of severe interaction tile 806. In response to detecting input 805e1, device 600 displays pregnancy interaction interface 802f in FIG. 8F. At FIG. 8E, device 600 detects input 805e2 (e.g., a touch input, an air gesture, a button press, a gaze, and/or a speech input) directed at pregnancy information option 822b. In response to detecting input 805e2, device 600 displays pregnancy interaction interface 802f in FIG. 8F. At FIG. 8E, device 600 detects input 805e3 (e.g., a touch input, an air gesture, a button press, a gaze, and/or a speech input) directed at additional information option 808b. In response to detecting input 805e3, device 600 displays general interaction interface 802c in FIG. 8H.

At FIG. 8F, in response to detecting input 805e1 and/or 805e2, device 600 displays pregnancy interaction interface 802f. Pregnancy interaction interface 802f includes information about interactions between active medications and pregnancy. In some embodiments, pregnancy interaction interface 802f does not include information corresponding to other interaction factors (e.g., alcohol, marijuana, tobacco, and/or lactation) and/or an interaction between two different medications (e.g., drug-on-drug interaction). Pregnancy interaction interface 802f distinguishes severe interactions from non-severe interactions. As depicted, pregnancy interaction interface 802f includes severe pregnancy interaction tile 824a, which is similar to severe pregnancy interaction tile 818 of FIG. 8E but has a different state. In some embodiments, severe pregnancy interaction tile 824a includes different information and/or options than the information and/or options of severe pregnancy interaction tile 818 of FIG. 8E. Pregnancy interaction interface 802f includes pregnancy interaction tiles 824b, 824c, 824d, and 824c. In some embodiments, pregnancy interaction tiles 824b, 824c, and/or 824d include information corresponding to an active medication (e.g., allergy medication, escitalopram, and medication X, respectively) and being pregnant. Pregnancy interaction tiles 824b, 824c, and/or 824d also include show more options 826b, 826c, and 826d that, when selected, causes device 600 to display additional information about an interaction between a respective medication (e.g., allergy medication, escitalopram, and/or medication X) and pregnancy. Pregnancy interaction tile 824e does not include information about an interaction between pain medication and pregnancy because device 600 determines that there is no information available (e.g., pain medication was a custom medication and, as such, no information is available for the pain medication and/or device 600 could not identify any interaction information based on the available information for pain medication). At FIG. 8F, device 600 detects input 805f (e.g., a touch input, an air gesture, a button press, a gaze, and/or a speech input) directed to show more option 826a of severe pregnancy interaction tile 824a. In response to detecting input 805f, device 600 displays interaction interface 802g of FIG. 8G.

At FIG. 8G, interaction interface 802g includes additional interaction information for the interaction between warfarin and pregnancy. In some embodiments, device 600 displays interaction interface 802g in response to detecting input 805cl of FIG. 8E.

At FIG. 8H, in response to detecting input 805e3 of FIG. 8E, device 600 displays general interaction interface 802c. General interaction interface 802c of FIG. 8H is similar to general interaction interface 802c of FIG. 8C, but has a different state. General interaction interface 802c of FIG. 8H does not include information about interactions between the active medications and pregnancy. Active interaction factor tile 813 includes an indication that the pregnancy interaction factor is active. In some embodiments, active interaction factor tile 813 does not include an indication that the pregnancy interaction factor is active, as depicted by dashed box 828. As depicted, the alcohol interaction factor is not active. In some embodiments, the alcohol interaction factor is active. In such embodiments, device 600 displays interactions between alcohol and the active medications in general interaction interface 802c of FIG. 8H (similar to what is described with respect to FIG. 8C).

At FIG. 8I, the pregnancy interaction factor is active and all other interaction factors are inactive. Device 600 displays logging interface 602b with pregnancy information tile 830 based on a determination that the pregnancy interaction factor is active (and/or has been activated since last displaying logging interface 602b). In some embodiments, device 600 displays logging interface 602b with pregnancy information tile 830 based on a determination that there is not a severe interaction between the pregnancy interaction factor and an active medication. In some embodiments, device 600 displays a severe interaction tile similar to severe pregnancy interaction tile 818 (e.g., instead of and/or in addition to pregnancy information tile 830) based on a determination that there is a severe interaction between the pregnancy interaction factor and an active medication. Device 600 displays pregnancy information tile 830 above logging area 613 and/or above active medication area 615. As depicted, pregnancy information tile 830 does not include a representation of a medication that is a source of any particular interaction and does not include severe graphical element 820. In some embodiments, device 600 determines that the pregnancy interaction factor is activated and then displays pregnancy information tile 830 upon initial display of logging interface 602b after the pregnancy interaction factor is activated (e.g., and while the pregnancy interaction factor continues to be active). In some embodiments, pregnancy information tile 830 is not displayed again while the pregnancy interaction factor is activated (e.g., whereas severe pregnancy interaction tile 818 is displayed whenever device 600 determines there is a severe interaction between a medication and being pregnant).

At FIG. 8I, device 600 displays pregnancy information options 822c and 822b in different portions of logging interface 602b. As depicted, device 600 displays pregnancy information option 822c at a top portion of logging interface 602b (e.g., and/or in pregnancy information tile 830). In some embodiments, pregnancy information option 822c is similar to pregnancy information option 822a but has a different state (e.g., pregnancy information option 822c is displayed in pregnancy interaction tile 811). Device 600 displays pregnancy information option 822b at a bottom portion of logging interface 602b (e.g., and/or in pregnancy interaction tile 811). Pregnancy interaction tile 811 does not include information (e.g., “1 severe”) about a severe interaction because warfarin is not an active medication (and/or none of the active medications cause a severe interaction). Pregnancy interaction tile 811 includes information about non-severe interactions (e.g., “3”). As described with respect to FIGS. 8F and 8J, there are three interactions based on three of the active medications having an interaction with pregnancy. In some embodiments, pregnancy information option 822b is similar to pregnancy information option 822a and/or pregnancy information option 822c, but has a different state.

At FIG. 8I, device 600 detects a request to view additional information corresponding to the pregnancy interaction factor. For example, device 600 detects input 805il (e.g., a touch input, an air gesture, a button press, a gaze, and/or a speech input) directed at pregnancy information option 822c of pregnancy information tile 830. In response to detecting input 805il, device 600 displays pregnancy interaction interface 802f in FIG. 8J. At FIG. 8I, device 600 detects input 80512 (e.g., a touch input, an air gesture, a button press, a gaze, and/or a speech input) directed at pregnancy information option 822b. In response to detecting input 80512, device 600 displays pregnancy interaction interface 802f in FIG. 8J. At FIG. 8I, device 600 detects input 80513 (e.g., a touch input, an air gesture, a button press, a gaze, and/or a speech input) directed at close option 834. In some embodiments, in response to detecting input 80513, device 600 stops displaying pregnancy information tile 830. In such embodiments, device 600 maintains display of pregnancy interaction tile 811 without displaying pregnancy information tile 830. In some embodiments, device 600 does not re-display pregnancy information tile 830 while the pregnancy interaction factor is active. In some embodiments, pregnancy information tile 830 is re-displayed when the pregnancy interaction factor is deactivated and then reactivated.

At FIG. 8J, device 600 displays pregnancy interaction interface 802f in response to detecting input 805il and/or 80512. Pregnancy interaction interface 802f of FIG. 8J is similar to pregnancy interaction interface 802f of FIG. 8F but has a different state. For example, pregnancy interaction interface 802f of FIG. 8J does not include severe pregnancy interaction tile 824a based on device 600 determining that there is not a severe interaction between pregnancy and an active medication (e.g., warfarin is not an active medication at FIG. 8J). In some embodiments, device 600 detects input 805j (e.g., a touch input, an air gesture, a button press, a gaze, and/or a speech input) directed to show more option 826d. In such embodiments, in response to detecting input 805j, device 600 displays a user interface similar to interaction interface 802g of FIG. 8G but including information corresponding to an interaction between medication X and pregnancy.

At FIG. 8K, the lactation interaction factor and the pregnancy interaction factor are active while all other interaction factors are inactive. Device 600 displays logging interface 602b with lactation information tile 836 based on a determination that the lactation interaction factor is active. In some embodiments, device 600 displays logging interface 602b with lactation information tile 836 based on a determination that there is not a severe interaction between the lactation interaction factor and an active medication. Device 600 displays lactation information tile 836 above logging area 613 and/or above active medication area 615. As depicted, lactation information tile 836 does not include a representation of a medication that is a source of an interaction and does not include severe graphical element 820. In some embodiments, device 600 displays lactation information tile 836 upon initial display of logging interface 602b after the lactation interaction factor is activated (e.g., and while the lactation interaction factor continues to be active). In some embodiments, lactation information tile 836 is not displayed again while the lactation interaction factor remains activate (e.g., whereas a severe lactation interaction tile is displayed whenever device 600 determines there is a severe interaction between a medication and lactation). In some embodiments, device 600 displays lactation information tile 836 concurrently with pregnancy information tile 830. In some embodiments, device 600 does not display lactation information tile 836 and pregnancy information tile 830 concurrently. In some embodiments, lactation information tile 836 and pregnancy information tile 830 are displayed at different times (e.g., the lactation interaction factor and the pregnancy interaction factor are activated at different times).

At FIG. 8K, device 600 displays lactation information options 838a and 838b in different portions of logging interface 602b. As depicted, device 600 displays lactation information option 838a at a top portion of logging interface 602b (e.g., and/or in lactation information tile 836). Device 600 displays lactation information option 838b at a bottom portion of logging interface 602b (e.g., and/or in lactation interaction tile 839). Lactation interaction tile 839 does not include information (e.g., “1 severe”) about a severe interaction because none of the active medications have a severe interaction with lactation. Lactation interaction tile 839 includes information about non-severe interactions (e.g., “3”). As described with respect to FIG. 8L, there are three interactions based on lactating and three of the active medications. In some embodiments, device 600 displays a severe lactation interaction tile (e.g., similar to severe pregnancy interaction tile 818) in logging interface 602b based on a determination that there is a severe interaction between lactation and an active medication. In such embodiments, the severe lactation interaction tile includes a lactation information option similar to lactation information options 838a and 838b. In some embodiments, lactation information option 838a is similar to lactation information option 838b, but has a different state.

At FIG. 8K, device 600 detects a request to view additional information corresponding to the lactation interaction factor. For example, device 600 detects input 805kl (e.g., a touch input, an air gesture, a button press, a gaze, and/or a speech input) directed at lactation information option 838a of lactation interaction tile 839. In response to detecting input 805k1, device 600 displays lactation interaction interface 8021 in FIG. 8L. At FIG. 8I, device 600 detects input 805k2 (e.g., a touch input, an air gesture, a button press, a gaze, and/or a speech input) directed at lactation information option 838b. In response to detecting input 805k2, device 600 displays lactation interaction interface 8021 in FIG. 8L. At FIG. 8K, device 600 detects input 805k3 (e.g., a touch input, an air gesture, a button press, a gaze, and/or a speech input) directed at pregnancy information option 822b. In some embodiments, in response to detecting input 805k3, device 600 displays pregnancy interaction interface 802f in FIG. 8J. At FIG. 8K, device 600 detects input 805k4 (e.g., a touch input, an air gesture, a button press, a gaze, and/or a speech input) directed at general interaction tile 810. In response to detecting input 805k2, device 600 displays a general interaction interface similar to general interaction interface 802c in FIG. 8H.

At FIG. 8L, device 600 displays lactation interaction interface 8021 (e.g., in response to detecting input 805kl and/or 805k2). Lactation interaction interface 8021 includes information about interactions between active medications and lactation. In some embodiments, lactation interaction interface 8021 does not include information corresponding to other interaction factors (e.g., alcohol, marijuana, tobacco, and/or pregnancy) and/or an interaction between two different medications (e.g., a drug-on-drug interaction). Lactation interaction interface 8021 includes lactation interaction tiles 840a, 840b, 840c, and 840d. In some embodiments, lactation interaction tiles 840a, 840b, 840c, and 840d include information corresponding to an active medication and lactating. Lactation interaction tiles 840a, 840b, 840c, and 840d also include show more options 842a, 842b, and 842c that, when selected, cause device 600 to display additional information about an interaction between a respective medication (e.g., allergy medication, escitalopram, and/or medication X) and lactation. Lactation interaction tile 840d does not include information about an interaction between pain medication and lactation because device 600 determines that there is no information available (e.g., pain medication was a custom medication and, as such, no information is available for the pain medication and/or device 600 could not identify any interaction information based on the available information for pain medication). At FIG. 8L, device 600 detects input 805l (e.g., a touch input, an air gesture, a button press, a gaze, and/or a speech input) directed to show more option 842c of lactation interaction tile 840c. In response to detecting input 805l, device 600 displays an interaction interface (e.g., similar to interaction interface 802g of FIG. 8G) that includes information about an interaction between medication X and lactation.

At FIG. 8L, in some embodiments, lactation interaction interface 8021 distinguishes severe interactions from non-severe interactions. In some embodiments, lactation interaction interface 8021 includes a severe lactation interaction tile (e.g., similar to severe pregnancy interaction tile 824a) based on device 600 determining that there is a severe interaction between lactation and an active medication.

FIGS. 9A-9B are flow diagrams illustrating a method for displaying interaction factors, in accordance with some embodiments. Method 900 is performed at a computer system (e.g., 100, 300, 500, 600, and/or 644) (e.g., a smartphone, a tablet computer, a laptop computer, a desktop computer, and/or a head mounted device (e.g., a head mounted augmented reality and/or extended reality device)) that is in communication with one or more display generation components (e.g., 601) (e.g., a display controller, a touch-sensitive display system, a monitor, and/or a head mounted display system) and one or more input devices (e.g., 601) (e.g., a touch-sensitive surface, a keyboard, a controller, and/or a mouse) (in some embodiments, the computer system is in communication with one or more cameras (e.g., an infrared camera, a depth camera, and/or a visible light camera)). Some operations in method 900 are, optionally, combined, the orders of some operations are, optionally, changed, and some operations are, optionally, omitted.

As described below, method 900 provides an intuitive way for displaying interaction factors. The method reduces the cognitive burden on a user for access and/or view interaction factors, thereby creating a more efficient human-machine interface. For battery-operated computing devices, enabling a user to access and/or view faster and more efficiently conserves power and increases the time between battery charges.

The computer system detects (902), via the one or more input devices, a request (e.g., 605a4 and/or 805a4) (e.g., one or more inputs) to add a medication (e.g., a request to add one of the medications displayed in 615) as a medication to a set of one or more tracked medications that are tracked (e.g., the active medications displayed in 615) (e.g., a scheduled medication and/or an as-needed medication) by a medication tracking application (e.g., the medication tracking application of FIGS. 6A-6Q and/or FIGS. 8A-8L) (e.g., an application that includes a schedule for taking one or more medications and/or an application that notifies a user when a medication is scheduled to be taken).

In response to detecting the request to add the medication to the set of one or more tracked medications that are tracked by the medication tracking application, the computer system adds (904) the medication to the set of one or more tracked medications (e.g., a newly added medication will be added to the medications displayed in 615).

After adding the medication and while the medication is a tracked medication (in some embodiments, in response detecting the request to add the medication as a medication to be tracked in the medication tracking application), the computer system displays (906), via the one or more display generation components, a user interface (e.g., 602b) of the medication tracking application.

Displaying the user interface includes, in accordance with a determination that a respective interaction factor associated with the set of one or more tracked medications corresponds to a first type of interaction factor (908) (e.g., alcohol, marijuana, and/or tobacco in FIG. 8A) (e.g., alcohol, marijuana, and/or tobacco) and in accordance with a determination that a first set of criteria is satisfied (e.g., there is a severe interaction risk between alcohol and nitroglycerin, as depicted in FIG. 8B) (e.g., there is a “severe” risk of a drug interaction and/or there is a high risk of a drug interaction), the computer system displaying (910), at a first portion (e.g., in a severe interaction tile area, a portion above 613, and/or a portion above 615) in the user interface (e.g., a top portion of the user interface, a portion that is adjacent to a scheduled action for a medication, a first platter, and/or a first tile) and via the one or more display generation components, a first selectable object (e.g., 808a) that, when selected, causes the computer system to display information (e.g., information about a drug interaction and/or information about a medication that is being tracked and the first type of user-selected interaction factor) corresponding to the first type of interaction factor (e.g., selection of 808a in FIG. 8B displays 802c of FIG. 8C) (e.g., without displaying information corresponding to a second type of interaction factor). In some embodiments, the first set of criteria includes a criterion that is satisfied a drug interaction (e.g., an interaction (e.g., with a different medication and/or user-defined factors (e.g., alcohol, marijuana, and/or tobacco)) that changes (e.g., increases or decreases) the effectiveness the respective medication and/or an interaction that causes (e.g., introduces, increases, and/or decreases) a risk of a side effect by taking a respective medication) meets and/or exceeds a threshold severity level (e.g., low, medium, or high). In some embodiments, the first set of criteria includes a criterion that is satisfied based on an interaction meets and/or exceeds a threshold level of severity (e.g., there is a “severe” drug interaction and/or there is a critical drug interaction).

Displaying the user interface includes, in accordance with a determination that a respective interaction factor associated with the set of one or more tracked medications corresponds to a first type of interaction factor (908) (e.g., alcohol, marijuana, and/or tobacco in FIG. 8A) (e.g., alcohol, marijuana, and/or tobacco) and in accordance with a determination that the first set of criteria is not satisfied (e.g., there is not a severe interaction between alcohol and an active medication) (e.g., there is not a “severe” risk of a drug interaction and/or there is not a high risk of a drug interaction), the computer system forgoing displaying (912), at the first portion in the user interface, the first selectable object (e.g., as depicted in FIG. 8D).

Displaying the user interface includes, in accordance with a determination that the respective interaction factor associated with the set of one or more tracked medications corresponds to a second type of interaction factor (e.g., pregnancy and/or lactation in FIG. 8A) (e.g., pregnancy and/or lactation) and independent of (e.g., apart from and/or regardless of) the first set of criteria being satisfied (e.g., regardless of whether there is a severe interaction between pregnancy and/or lactation and an active medication), the computer system displaying (914), at the first portion in the user interface and via the one or more display generation components, a second selectable object (e.g., 822a, 822c, and/or 838a) that, when selected, causes the computer system to display information (e.g., information about the second type of interaction factor (e.g., health information related to being pregnant and/or lactating), information that includes an interaction with a currently tracked medication and the second type of interaction factor, information that does not include an interaction between a medication and the first type of interaction factor, information about a drug interaction, and/or information about a medication that is being tracked and the second type of user-selected interaction factor) corresponding to the second type of interaction factor (e.g., selecting 822a in FIG. 8F displays 802f of FIG. 8I; selecting 822c displays 802f in FIG. 8J; and/or selecting 838a in FIG. 8K displays 8021 of FIG. 8L). In some embodiments, the computer system displays the information corresponding to the second type of interaction factor without displaying the information corresponding to the first type of interaction factor. In some embodiments, in accordance with a determination that the respective interaction factor associated with the set of one or more tracked medications does not correspond to the second type of interaction factor, the computer system does not display, at the first location, the second selectable object that, when selected, causes the computer system to display information corresponding to the second type of user-selected interaction factor. Displaying a user interface of a medication tracking application that conditionally includes displaying a first selectable object that, when selected, causes the computer system to display information corresponding to the first type of interaction factor or a second selectable object that, when selected, causes the computer system to display information corresponding to the second type of interaction factor based on when the respective interaction factor associated with the set of one or more tracked medications corresponds to a first type of interaction factor or a second type of interaction factor performs an operation when a set of conditions has been met without requiring further user input, provides visual feedback about whether an interaction factor associated with the medication corresponds to a first type of interaction factor or a second type of interaction factor, and improves how drug interactions are displayed in a medication tracking user interface.

In some embodiments, displaying the second selectable object includes, in accordance with a determination that the second type of interaction factor satisfies the first set of criteria (e.g., there is a severe interaction between warfarin and pregnancy in FIG. 8F) (e.g., a set of interaction criteria and/or a set of severity level criteria), the computer system displaying the second selectable object with a first graphical element (e.g., 820 as depicted in FIG. 8E) (e.g., tile, icon, text, image, shape, and/or color). In some embodiments, the first graphical element identifies a medication having an interaction with the second type of interaction factor. In some embodiments, displaying the second selectable object includes, in accordance with a determination that the second type of interaction factor does not satisfy the first set of criteria (e.g., there is not a severe interaction between an active medication and pregnancy and/or lactation), displaying the second selectable object without the first graphical element (e.g., as depicted in FIG. 8I) (and/or with a second graphical element that is different from the first graphical element). In some embodiments, displaying the second selectable object without the first graphical element includes an indication to learn more about the second type of interaction factor. Conditionally displaying the second selectable object with or without the first graphical performs an operation when a set of conditions has been met without requiring further user input, provides visual feedback about a state of the second type of interaction factor, and improves how drug interactions are displayed in a medication tracking user interface.

In some embodiments, the first graphical element includes an indication of a severity (e.g., the exclamation mark icon and/or “critical” of 820 in FIG. 8F) (e.g., mild severity, high severity, and/or critical) of an interaction between the medication and the second type of interaction factor (e.g., as depicted in FIG. 8F). In some embodiments, the indication of severity is displayed in a tile including the second type of interaction factor. Including an indication of a severity (e.g., mild severity, high severity, and/or critical) of an interaction between the medication and the second type of interaction factor as part of the first graphical element reduces the number of inputs (e.g., to select the second selectable object so as to view a severity of an interaction), provides visual feedback about the state of the second type of interaction factor, and improves how interactions are displayed in a medication tracking user interface.

In some embodiments, displaying the second selectable object with the first graphical element includes the computer system displaying an indication of a medication (e.g., text and/or icon of warfarin in FIG. 8F) (e.g., a name of the medication and/or an identification of the medication) of the set of one or more tracked medications that triggered (e.g., that caused and/or produced) the interaction with the second type of interaction factor (e.g., warfarin triggered the severe interaction with pregnancy in FIG. 8F) (e.g., the first graphical element identifies a medication that has a severe interaction with the second type of interaction factor). In some embodiments, displaying the second selectable object without the first graphical element includes the computer system displaying the second selectable object without an indication of a medication (e.g., 830 and/or 836 do not include an indication of a medication) (e.g., the previously added medication or a different medication) of the set of one or more tracked medications triggering an interaction with the second type of interaction factor (e.g., 830 and/or 836 do not include an indication of a medication that has an interaction with pregnancy and/or lactation, respectively) (e.g., the pregnancy and/or lactation tile do not identify a medication if there is not a severe interaction). Conditionally displaying the second selectable object with or without an indication of a medication that triggers an interaction with the second type of interaction factor reduces the number of inputs (e.g., to select the second selectable object so as to view a medication causing an interaction), provides visual feedback about the state of the second type of interaction factor, and improves how drug interactions are displayed in a medication tracking user interface.

In some embodiments, displaying the user interface includes, in accordance with a determination that the respective interaction factor corresponds to a third type of interaction factor (e.g., pregnancy and/or lactation) (e.g., pregnancy and/or lactation interaction factor) (and, in some embodiments, different from the second type of interaction factor and/or the first type of interaction factor), which is different from the second type of interaction factor and independent of the first set of criteria being satisfied, the computer system displaying, at the first portion in the user interface and via the one or more display generation components, a third selectable object (e.g., 838a and/or 822c) that, when selected, causes the computer system to display information corresponding to the third type of interaction factor (e.g., 600 displays 822c and/or 838a, as depicted in FIG. 8K) (e.g., the computer system displays separate buttons for general interaction factors interactions, pregnancy interaction factors, and lactation interaction factors). In some embodiments, the computer system displays the information corresponding to the third type of interaction factor without displaying the information corresponding to the first type of interaction factor and without displaying the information corresponding to the second type of interaction factor. In some embodiments, the first selectable object, when selected, displays a first user interface corresponding to the first type of interaction factor (e.g., information about one or more medications interacting with the first type of interaction factor). In some embodiments, the second selectable object, when selected, displays a second user interface corresponding to the second type of interaction factor that is different from the first user interface (e.g., information about one or more medications interacting with the second type of interaction factor and/or does not include information corresponding to the first type of interaction factor). In some embodiments, the third selectable object, when selected, displays a third user interface corresponding to the third type of interaction factor that is different from the first user interface and the second user interface (e.g., information about one or more medications interacting with the third type of interaction factor and/or the third user interface does not include information corresponding to the first type of interaction factor and does not include information corresponding to the second type of interaction). Conditionally displaying a third selectable object that, when selected, causes the computer system to display information corresponding to a third type of interaction factor, which is different from the second type of interaction factor, when the respective interaction factor corresponds to a third type of interaction factor, performs an operation when a set of conditions has been met without requiring further user input, provides visual feedback about whether an interaction factor associated with the medication corresponds to a third type of interaction factor, and improves how drug interactions are displayed in a medication tracking user interface.

In some embodiments, after adding the medication and while the medication is a tracked medication (e.g., and while the second type of interaction factor is enabled), the computer system displays, via the one or more display generation components, the user interface of the medication tracking application with the second selectable object (e.g., 822c and/or 838a), wherein the second selectable object is displayed independent of (e.g., without and/or regardless of) an interaction threshold (e.g., the second selectable object is displayed independent of a degree of interaction a drug has with the second type of interaction factor (e.g., a severe and/or critical interaction threshold)) being met (e.g., 822c and/or 838a are displayed even though there is not a severe interaction). In some embodiments, after displaying the second selectable object at the first portion in the user interface independent of the interaction threshold being met (e.g., and while the second type of interaction factor continues to be enabled (e.g., pregnancy and/or lactation factors are still active and/or haven't been disabled); and/or after the second selectable object is not displayed at the first portion in the user interface (e.g., the second selectable object has been dismissed and/or closed)), the computer system displays, via the one or more display generation components, the user interface without the second selectable object at the first portion in the user interface unless the interaction threshold is met (e.g., 700 stops displaying 822c and/or 838a and 700 does not re-display 822a and/or 838a unless there is a severe interaction, such as the severe interaction depicted in FIG. 8E) (e.g., after a general “learn more” tile for pregnancy and/or lactation tile is displayed at the top of the medication tracking interface, the pregnancy and/or lactation tile is not displayed at the top again until there is a severe interaction between a medication and pregnancy and/or lactation factors). Displaying the user interface without the second selectable object at the first portion in the user interface unless the interaction threshold is met after the second selectable object is displayed at the first portion in the user interface independent of the interaction threshold being met declutters the user interface and performs an operation when a set of conditions has been met without requiring further user input.

In some embodiments, displaying the user interface includes the computer system displaying, via the one or more display generation components, a first interaction selectable object (e.g., 808b) at a second portion of the user interface (e.g., 808b is displayed in a bottom portion of 602b, 808b is displayed below 613, and/or 808b is displayed below 615) (e.g., a bottom portion of the user interface and/or a drug interaction tile), wherein the first interaction selectable object, when selected, causes the computer system to display interactions for the first type of interaction factor (e.g., selecting 808b causes 600 to display 802c in FIGS. 8C and/or 8H) (e.g., an interaction between a medication and the first type of interaction factor) (and/or interactions between two different medications being tracked). In some embodiments, the first interaction selectable object is displayed independent of the first type of interaction factor being enabled (e.g., active and/or turned on) (e.g., the “general” drug interaction factor button is displayed regardless of whether alcohol, marijuana, and/or tobacco interaction factors are enabled). In some embodiments, displaying the user interface includes, in accordance with a determination that the second type of interaction factor is enabled (e.g., pregnancy interaction factor and/or lactation interaction factor are enabled in FIGS. 8E-8L) (e.g., active and/or turned on), the computer system displaying, via the one or more display generation components, a second interaction selectable object (e.g., 822b and/or 838b are displayed in FIGS. 8E-8L) at the second portion of the user interface (e.g., 822b and/or 838b are displayed in a bottom portion of 602b, 822b and/or 838b are displayed below 613, and/or 822b and/or 838b are displayed below 615) (e.g., a bottom portion of the user interface and/or a drug interaction tile), wherein the second interaction selectable object, when selected, causes the computer system to display the information corresponding to the second type of interaction factor (e.g., selecting 822b and/or 838b causes 600 to display 802f and/or 8021, respectively) (e.g., the first interaction selectable object is displayed regardless of the first type of interaction factor being enabled while the second interaction selectable object is displayed based on the second type of interaction factor being enabled). In some embodiments, the computer system displays the information corresponding to the second type of interaction factor without displaying the information corresponding to the first type of interaction factor. In some embodiments, in accordance with a determination that the second type of interaction factor is not enabled, the computer system forgoes displaying, via the one or more display generation components, the second interaction selectable object at the second portion of the user interface. Displaying a first interaction selectable object, where the first interaction selectable object, when selected, causes the computer system to display interactions for the first type of interaction factor, while conditionally displaying a second interaction selectable object at the second portion of the user interface, where the second interaction selectable object, when selected, causes the computer system to display the information corresponding to the second type of interaction factor performs an operation when a set of conditions has been met without requiring further user input, provides visual feedback about whether the second type of interaction factor is enabled, and improves how interaction factors are displayed in a medication tracking user interface.

In some embodiments, the computer system detects, via one or more input devices, an input (e.g., 805k2, 805k3, and/or 805k4) (e.g., a button press, an air gesture, a gaze, and/or a touch gesture) directed to a respective selectable object. In some embodiments, in response to detecting the input directed to the respective selectable object and in accordance with a determination that the input is directed to the first selectable object (e.g., 808a), the computer system displays, via the one or more display generation components, the information corresponding to the first type of interaction factor (e.g., selection of 808a will cause 600 to display interaction information between the alcohol interaction factor and active medications in 802c, as depicted in FIG. 8C) and information corresponding to a type of interaction factor (e.g., marijuana interaction factor and/or tobacco interaction factor of FIG. 8A) that is different from the first type of interaction factor (e.g., selection of 808a will cause 600 to display interactions between an active medication in 802c and the alcohol interaction factor, the marijuana interaction factor, and/or tobacco interaction factor, as described with respect to FIG. 8C) (e.g., selecting a drug interaction button causes display of drug interactions with multiple interaction factors (e.g., alcohol, marijuana, and/or tobacco)). In some embodiments, in response to detecting the input directed to the respective selectable object and in accordance with a determination that the input is directed to the second selectable object (e.g., 822a, 822c, and/or 838a), the computer system displays, via the one or more display generation components, the information corresponding to the second type of interaction factor without displaying the information corresponding to the first type of interaction factor (e.g., selecting 822a and/or 822c causes 600 to display 802f, which does not include interaction information for the alcohol interaction factor, the marijuana interaction factor, and/or the tabaco interaction factor, as depicted in FIG. 8J and/or FIG. 8F; selecting 838a causes 600 to 8021, which does not include interaction information for the alcohol interaction factor, the marijuana interaction factor, and/or the tabaco interaction factor, as depicted in FIG. 8L) (e.g., selecting a pregnancy interaction button (or, in some embodiments, lactation interaction button) causes display of a drug interaction with pregnancy (or, in some embodiments, lactation) without displaying information for other drug interaction factors (e.g., alcohol, marijuana, and/or tobacco)). In some embodiments, displaying the information corresponding to the second type of interaction factor includes not displaying information corresponding to a type of interaction factor that is different from the second type of interaction factor (e.g., selecting a pregnancy interaction button (or, in some embodiments, lactation interaction button) causes display of a drug interaction with pregnancy only (or, in some embodiments, lactation only)). Displaying information corresponding to the first type of interaction factor and information corresponding to a type of interaction factor that is different from the first type of interaction factor when an input is directed to the first selectable object and/or displaying information corresponding to the second type of interaction factor without displaying information corresponding to the information corresponding to the first type of interaction factor improves how interaction factors are displayed in a medication tracking user interface and declutters the user interface by selectively displaying limited interaction factors based on user input.

In some embodiments, the information corresponding to the first type of interaction factor and the information corresponding to the type of interaction factor that is different from the first type of interaction factor is displayed without displaying the information corresponding to the second type of interaction factor (e.g., 802c does not include interaction information between an active medication and pregnancy and/or lactation) (e.g., selecting the first selectable object causes display of a drug interaction with multiple interaction factors (e.g., alcohol, marijuana, and/or tobacco) without displaying a drug interaction with pregnancy and/or lactation interaction factors). Displaying the information corresponding to the first type of interaction factor and the information corresponding to the type of interaction factor that is different from the first type of interaction factor without displaying the information corresponding to the second type of interaction factor improves how interaction factors are displayed in a medication tracking user interface and declutters the user interface by selectively displaying limited interaction factors based on user input.

In some embodiments, in response to detecting the input (e.g., 805f and/or 80511) directed to the respective selectable object (e.g., 822a and/or 822c) and in accordance with the determination that the input is directed to the second selectable object and in accordance with a determination that an interaction between a first medication of the set of one or more tracked medications and the second type of interaction factor satisfies a threshold severity level (e.g., there is a severe interaction between warfarin and pregnancy in FIGS. 8E-8F) (e.g., low, medium, or high), the computer system displays, via the one or more display generation components, the first medication with a severity graphical element (e.g., 820) (e.g., icon, text, and/or image) (and/or at a first location in a graphical user interface). In some embodiments, in response to detecting the input (e.g., 805f and/or 80511) directed to the respective selectable object (e.g., 822a and/or 822c) and in accordance with the determination that the input is directed to the second selectable object and in accordance with a determination that the interaction between the first medication and the second type of interaction factor does not satisfy the threshold severity level (e.g., there is not a severe interaction between pregnancy and allergy medication, escitalopram, and/or medication X in FIGS. 8E-8F) (e.g., low, medium, or high), the computer system displays, via the one or more display generation components, the first medication without the severity graphical element (e.g., as depicted in FIG. 8E) (and/or displaying the medication at a second location in a graphical user interface, different from the first location). In some embodiments, the severity graphical element indicates a severity level of the interaction (e.g., critical and/or serious). Conditionally displaying the medication with or without the severity graphical element if the interaction between the medication and the second type of interaction factor satisfies the threshold severity level performs an operation when a set of conditions has been met without requiring further user input and improves how interaction factors are displayed in a medication tracking user interface.

In some embodiments, displaying the user interface includes the computer system displaying, via the one or more display generation components, the first selectable object (e.g., 808b) and the second selectable object (e.g., 822b) at a second portion (e.g., a bottom portion of the user interface, a portion that is below a scheduled action for a medication, a second platter, and/or a second tile) of the user interface that is different from the first portion of the user interface (e.g., 808b, 838b, and/or 822b are displayed in a bottom portion of 602b, 808b, 838b, and/or 822b are displayed below 613, and/or 808b, 838b, and/or 822b are displayed below 615) (e.g., the first selectable object and the second selectable object are displayed at the second portion while the first selectable object and the second selectable object are conditionally displayed at the first portion). In some embodiments, the computer system detects an input to a close selectable object corresponding to the second selectable object that is displayed in the first portion of the user interface and, in response, displays the second selectable object at the second portion without displaying the second selectable object that is displayed in the first portion of the user interface (e.g., the computer system displays the second selectable object in the second portion of the user interface before and/or after the second selectable object is closed at the first portion of the user interface). Displaying the first selectable object and the second selectable object at a second portion of the user interface while conditionally displaying the first selectable object and the second selectable object at the first portion of the user interface performs an operation when a set of conditions has been met without requiring further user input, allows the computer system to surface the first selectable object and the second selectable object at a specific portion of the user interface when criteria is met, and improves how drug interactions are displayed in a medication tracking user interface.

In some embodiments, displaying the user interface includes the computer system displaying, at the second portion of the user interface and via the one or more display generation components, a fourth selectable object (e.g., 808b) that, when selected causes the computer system to display information corresponding to a fourth type of interaction factor (e.g., the alcohol interaction factor, the marijuana interaction factor, and/or the tabaco interaction factor of FIG. 8A) (e.g., information about the fourth type of interaction factor (e.g., health information related to being pregnant and/or lactating), information that includes an interaction with a currently tracked medication and the fourth type of interaction factor, information that does not include an interaction between a medication and the first type of interaction factor and/or the second type of interaction factor, information about an interaction between one drug and a different drug, and/or information about a medication that is being tracked and the fourth type of user-selected interaction factor) that is different from the first type of interaction factor and the second type of interaction factor (e.g., selection of 808a will cause 600 to display an interaction between an active medication and the alcohol interaction factor, the marijuana interaction factor, and/or tobacco interaction factor in 802c, as described with respect to FIG. 8C) (e.g., the computer system displays a button to view pregnancy drug interaction information, a button to view lactation drug interaction information, and a button to view general drug interaction information). Displaying a third selectable object, in addition to the first selectable object and the second selectable object, at a second portion of the user interface provides additional control options to view different interaction factors and improves how drug interactions are displayed in a medication tracking user interface.

Note that details of the processes described above with respect to method 900 (e.g., FIGS. 9A-9B) are also applicable in an analogous manner to the methods described herein. For example, method 700 optionally includes one or more of the characteristics of the various methods described above with reference to method 900. For example, a medication for which interaction factors are displayed according to method 900 is the same medication that is logged via method 700. As a further example, method 700 optionally includes features of method 900 related to displaying interaction factors. As a further example, method 700 optionally includes features of method 900 related to controlling when graphical objects for different interaction factors are displayed. As a further example, method 700 optionally includes features of method 900 related to displaying interaction information for interaction factors. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of tracked medication content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted tracked medication content that is of greater interest to the user. Accordingly, use of such personal information data enables users to have calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of medication tracking services, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, tracked medication content can be selected and delivered to users by inferring preferences based on non-personal information data or a bare minimum amount of personal information, such as the content being requested by the device associated with a user, other non-personal information available to the medication tracking services, or publicly available information.

What is claimed is:

1. A computer system configured to communicate with one or more display generation components and one or more input devices, comprising:
one or more processors; and
memory storing one or more programs configured to be executed by the one or more processors, the one or more programs including instructions for:
displaying, via the one or more display generation components, a representation of a medication that is scheduled to be taken at a respective time;
detecting, via the one or more input devices, a request to log an action associated with the medication; and
in response to detecting the request to log the action associated with the medication:
in accordance with a determination that the action associated with the medication corresponds to a last dose of the medication, displaying, via the one or more display generation components, a first type of visual element that indicates that the action associated with the medication has been logged; and
in accordance with a determination that the action associated with the medication does not correspond to the last dose of the medication, displaying, via the display one or more generation components, a second type of visual element that indicates that the action associated with the medication has been logged, wherein the second type of visual element is different from the first type of visual element.

2. The computer system of claim 1, wherein the first type of visual element includes a first selectable object that, when selected, cause the computer system to initiate process to modify a status of the medication.

3. The computer system of claim 2, wherein the process to modify the status of the medication includes displaying, via the one or more display generation components, an inactive medication selectable object that, when selected, causes the computer system to initiate a process to change the medication from an active medication to an inactive medication.

4. The computer system of claim 2, wherein the process to modify the status of the medication includes displaying, via the one or more display generation components, a scheduling selectable object that, when selected, causes the computer system to initiate a process to schedule one or more doses of the medication to be taken after the last dose.

5. The computer system of claim 4, the one or more programs further including instructions for:
detecting, via one or more input devices, a first set of one or more inputs that includes an input directed to the scheduling selectable object; and
in response to detecting the first set of one or more inputs, displaying a parameter user interface that includes one or more parameter selectable objects that, when selected, cause the computer system to configure a scheduling parameter for the one or more doses of the medication to be taken after the last dose.

6. The computer system of claim 5, wherein displaying the parameter user interface includes displaying a respective scheduling parameter for scheduling the one or more doses of the medication to be taken after the last dose, including:
in accordance with a determination that a first scheduling parameter was used to schedule the last dose, displaying the first scheduling parameter as the respective scheduling parameter; and
in accordance with a determination that a second scheduling parameter, different from the first scheduling parameter, was used to schedule the last dose, displaying the second scheduling parameter as the respective scheduling parameter.

7. The computer system of claim 6, the one or more programs further including instructions for:
while displaying the parameter user interface with the first scheduling parameter as the respective scheduling parameter, detecting, via the one or more input devices, a second set of one or more inputs;
in response to the second set of one or more inputs, changing the first scheduling parameter to a third scheduling parameter that is different from the first scheduling parameter; and
after changing the first scheduling parameter to the third scheduling parameter and before confirming a schedule for the one or more doses of the medication to be taken after the last dose, displaying, via the one or more display generation components, the parameter user interface with the third scheduling parameter as the respective parameter for scheduling one or more doses of the medication after the last dose.

8. The computer system of claim 5, wherein the one or more parameter selectable objects includes a last dose selectable object that, when selected, causes the computer system to initiate a process to set a date for a last dose of the medication.

9. The computer system of claim 1, wherein:
the computer system is a smart phone; and
the first type of visual element includes a medication state selectable object that, when selected, initiates a process to modify a status of the medication.

10. The computer system of claim 1, wherein:
the computer system is a smart watch;
the first type of visual element includes a selectable object that is different from a medication state selectable object that, when selected, initiates a process to modify a status of the medication; and
the first type of visual element does not include a medication state selectable object that, when selected, initiates a process to modify a status of the medication.

11. The computer system of claim 1, the one or more programs further including instructions for:
displaying, via the one or more display generation components, the second type of visual element with an indicator indicating an amount of time that has passed since logging the medication.

12. The computer system of claim 1, wherein the medication is scheduled to be active for a first time period and inactive for a second time period that is different from the first time period, the one or more programs further including instructions for:
in accordance with a determination that a current time corresponds to the first time period, displaying, via the one or more display generation components, a representation of the medication with a selectable object to initiate a process to log the medication; and
in accordance with a determination that the current time corresponds to the second time period, displaying, via the one or more display generation components, a representation that the medication is inactive.

13. The computer system of claim 1, the one or more programs further including instructions for:
detecting, via the one or more input devices, a request to provide a first medication tracking application access to one or more medications of a second medication tracking application that is different from the first medication tracking application; and
in response to detecting the request to provide the first medication tracking application access to the one or more medications of the second medication tracking application:
in accordance with a determination that the second medication tracking application includes a first medication, displaying, via the one or more display generation components, a first selectable object that initiates a process to provide the first medication tracking application access to the first medication; and
in accordance with a determination that the second medication tracking application includes a second medication, different from the first medication, displaying, via the one or more display generation components, a second selectable object that is different from the first selectable object and that initiates a process to provide the first medication tracking application access to the second medication.

14. The computer system of claim 1, the one or more programs further including instructions for:
detecting, via one or more input devices, a request to configure a schedule for one or more doses of the medication; and
in response to detecting the request to configure the schedule for the one or more doses of the medication:
displaying, via the one or more display generation components, a first dosage selectable object that, when selected, initiates a process to schedule a first dosage amount of the medication on a first day; and
displaying, via the one or more display generation components, a second dosage selectable object that, when selected, initiates a process to schedule a second dosage amount of the medication on a second day different from the first day, wherein the second dosage amount is different from the first dosage amount.

15. The computer system of claim 1, the one or more programs further including instructions for:
detecting, via one or more input devices, a request to configure a schedule for the medication; and
in response to detecting the request to configure the schedule for the medication:
displaying, via the one or more display generation components, a first time selectable object that, when selected, initiates a process to schedule the medication to be taken at a first time on a first day; and
displaying, via the one or more display generation components, a second time selectable object that, when selected, initiates a process to schedule the medication to be taken at a second time on a second day, wherein the second time is different from the first time, and wherein the second day is different from the first day.

16. The computer system of claim 1, the one or more programs further including instructions for:
after an action for the last dose of the medication has been logged, displaying, via the one or more display generation components, an indication that a schedule for the medication is complete.

17. The computer system of claim 1, wherein displaying the representation of the medication that is scheduled to be taken includes:
in accordance with a determination that the action associated with the medication corresponds to a last dose of the medication, displaying, via the one or more display generation components, the representation of the medication that is scheduled to be taken with a graphical element that indicates that the medication that is scheduled to be taken corresponds to the last dose of the medication; and
in accordance with a determination that the action associated with the medication does not correspond to the last dose of the medication, displaying, via the one or more display generation components, the representation of the medication that is scheduled to be taken without the graphical element that indicates that the medication that is scheduled to be taken corresponds to the last dose of the medication.

18. A non-transitory computer-readable storage medium storing one or more programs configured to be executed by one or more processors of a computer system that is in communication with one or more display generation components and one or more input devices, the one or more programs including instructions for:
displaying, via the one or more display generation components, a representation of a medication that is scheduled to be taken at a respective time;
detecting, via the one or more input devices, a request to log an action associated with the medication; and
in response to detecting the request to log the action associated with the medication:
in accordance with a determination that the action associated with the medication corresponds to a last dose of the medication, displaying, via the one or more display generation components, a first type of visual element that indicates that the action associated with the medication has been logged; and
in accordance with a determination that the action associated with the medication does not correspond to the last dose of the medication, displaying, via the one or more display generation components, a second type of visual element that indicates that the action associated with the medication has been logged, wherein the second type of visual element is different from the first type of visual element.

19. A method, comprising:
at a computer system that is in communication with one or more display generation components and one or more input devices:
displaying, via the one or more display generation components, a representation of a medication that is scheduled to be taken at a respective time;
detecting, via the one or more input devices, a request to log an action associated with the medication; and
in response to detecting the request to log the action associated with the medication:
in accordance with a determination that the action associated with the medication corresponds to a last dose of the medication, displaying, via the one or more display generation components, a first type of visual element that indicates that the action associated with the medication has been logged; and
in accordance with a determination that the action associated with the medication does not correspond to the last dose of the medication, displaying, via the one or more display generation components, a second type of visual element that indicates that the action associated with the medication has been logged, wherein the second type of visual element is different from the first type of visual element.
